(19) United States
(12) Patent Application Publication
(10) Pub. No.: US 2026/0275067 A1
(43) Pub. Date: Sep. 17, 2026

(54) TRANSPARENT GLAZING MATERIALS, ASSEMBLIES INCLUDING THE GLAZING MATERIALS, AND METHODS OF FORMING SAME

(71) Applicant: The Regents of the University of Colorado, a body corporate, Denver, CO (US)

(72) Inventors: Ivan I. Smalyukh, Boulder, CO (US); Eldho Abraham, Boulder, CO (US); Vladyslav Cherpak, Westminster, CO (US); Bohdan Senyuk, Boulder, CO (US); Taewoo Lee, Broomfield, CO (US); Jan Bart ten Hove, Ede (NL)

(21) Appl. No.: 19/163,177

(22) PCT Filed: Mar. 6, 2024
(86) PCT No.: PCT/US2024/018733

§ 371 Date: Sep. 8, 2025

Related U.S. Application Data
(60) Provisional application No. 63/450,286, filed on Mar. 6, 2023.

(51) Int. Cl. C08J 9/28; B32B 17/06; C08J 9/00

(52) U.S. Cl. CPC C08J 9/28; B32B 17/067; C08J 9/0085; B32B 2255/02; B32B 2262/062; B32B 2262/16; B32B 2305/022; B32B 2305/026; B32B 2307/73; B32B 2551/00; C08J 2205/026; C08J 2205/042

(57) ABSTRACT

Transparent glazing materials, assemblies including the glazing material(s), and methods of forming and using the glazing materials and assemblies are provided. Exemplary glazing material comprising an aerogel that includes a network of cellulose nanofibers and silicon functional groups bonded to surfaces of the cellulose nanofibers.

### CROSS-REFERENCE TO RELATED APPLICATIONS

This application claims priority to U.S. Provisional Application No. 63/450,286, entitled “HIGHLY TRANSPARENT SILANIZED CELLULOSE AEROGELS FOR BOOSTING ENERGY EFFICIENCY OF GLAZING IN BUILDINGS,” and filed Mar. 6, 2023, the contents of which are hereby incorporated herein by reference.

### STATEMENT REGARDING FEDERALLY-SPONSORED RESEARCH OR DEVELOPMENT

This invention was made with government support under grant number DE-AR0000743 awarded by the U.S. Department of Energy. The government has certain rights in the invention.

### BACKGROUND OF THE DISCLOSURE

To provide desired indoor conditions irrespective of the outdoor environment at little or no additional energy supply, building envelopes are generally configured to mitigate the interior-exterior exchange of energy through thermal conduction, convection and emission. To achieve this with glazing is especially challenging because of the typically stringent requirements on visible-range transparency and haze. While a current approach to this challenge utilizes insulating glass units (IGUs) with air or fill gas, high thermal-barrier performance of such IGUs requires large gap thickness between glass panes, which in turn is limited by gas convection, number of panes and structural constraints. The use of much thinner vacuum-insulated glass units, on the other hand, is limited by the seal integrity and high costs. Low-emissivity silver and other coatings allow for limiting the energy loss due to black-body-like electromagnetic emissivity originating from the room-temperature building's interior, though such coatings can capture only a fraction of escaping energy at a cost of deteriorating visible-range transparency. Aerogels, highly thermally insulating materials used in applications ranging from pipe insulation to a Mars rover, have been highly thought after for applications inside IGUs as a solid material replacement for gas fillers, because they stand out as a class of materials capable of outperforming still air and other gas fillers as efficient thermal barriers. However, conventional aerogels are typically mechanically fragile and strongly scatter light. Manufacturing aerogels with low haze, high transparency, mechanical robustness and at building-relevant scales and costs has also remained a challenge. Development of transparent aerogels, such as cellulose-based aerogels, remained limited to small scales while also featuring haze and transparency characteristics still inadequate for uses in most types of glazing. While the technological solutions for controlling thermal-range emissivity are adequate for some applications and the recent advent of new electrochromic approaches may address the needs of solar gain and privacy control, the lack of good transparent thermal barriers strongly limits the energy efficiency of window technologies. Accordingly, improved glazing materials, assemblies including the glazing materials, and methods of forming and using the glazing materials and assemblies are desired.

Any discussion, including discussion of problems and solutions, set forth in this section, has been included in this disclosure solely for the purpose of providing a context for the present disclosure, and should not be taken as an admission that any or all of the discussion was known at the time the invention was made or otherwise constitutes prior art.

### SUMMARY

This summary may introduce a selection of concepts in a simplified form, which may be described in further detail below. This summary is not intended to necessarily identify key features or essential features of the claimed subject matter, nor is it intended to be used to limit the scope of the claimed subject matter.

In accordance with examples of the disclosure, techniques for scalable manufacturing of highly transparent silanized cellulose aerogels (SiCellA) with material characteristics suitable for glazing applications and the aerogels are disclosed. These highly thermally insulating SiCellA materials, sandwiched between glass panes, may allow for windows with high resistance R to heat flow (e.g., R-5 and higher, where R-values are in units of h·ft²·° F.·Btu) and a geometric formfactor of a conventional double pane IGU, as well as glazing for daylighting and skylights, potentially exceeding the current standards and targets, not only for windows, but even for building walls. While the deployment of IGUs with air or other gas fillers is limited by convection at large inter-pane gaps, as well as by reflections of light from glass-air interfaces of multi-pane IGUs, no such intrinsic limitations exist for SiCellA-based IGUs. This aerogel-based glazing materials allows for the building envelopes to be designed to better take advantage of external conditions to provide natural occupant comfort. As set forth in more detail below, the SiCellA films can be used as IGU fillers and in multi-pane IGU designs to replace the inner glass panes, as well as are fully compatible with the existing solutions for thermal-range emissivity and solar gain control. Aerogels described herein can provide a holistic solution to the energy management challenges that building technologies face, even helping the next generation of buildings harness energy from the environment.

In accordance with embodiments of the disclosure, a transparent glazing material is provided. Exemplary transparent glazing material include an aerogel comprising a network of cellulose nanofibers and silicon functional groups bonded to surfaces of the cellulose nanofibers, wherein a thermal conductivity of the transparent glazing material is less than 26 mW/(K·m) or less than 20 mW/(K·m) or less than 15 mW/(K·m). In accordance with examples of these embodiments, a haze of the transparent glazing material is less than 2.5%, less than 2%, less than 1.5%, or less than 1%. In accordance with further examples, a transparency of the transparent glazing material is greater than 97% in the visible light spectrum. In accordance with yet further examples, the transparent glazing material exhibits superhydrophobicitv. In accordance with yet further examples, an average width of the cellulose nanofibers is less than 15 nm or 10 nm or between about 4 nm and about 6 nm or between 1 and 15 or between 1 and 10 nm. Additionally or alternatively, an average length of the cellulose nanofibers is greater than 100 nm or greater than 1000 nm or between about 200 nm and about 2000 nm or between 100 and 2000 nm or up 5000 nm. In accordance with further examples, the aerogel is optically anisotropic. In accordance with further examples, an average pore size of the aerogel is less than 100 nm or between about 2 nm and about 50 nm.

In accordance with additional embodiments of the disclosure, an assembly includes a transparent glazing material and a first (e.g., glass and/or transparent) pane. Exemplary assemblies can include a substrate attached to the transparent glazing material. The substrate can be or include, for example, one or more of plastic and glass. In accordance with examples of the disclosure, the transparent glazing material is attached to the substrate via electrostatic charge. In accordance with further examples, the assembly includes a low-emissivity coating between the substrate and the transparent glazing material. In accordance with further examples, the assembly includes a second (e.g., glass) pane, wherein the transparent glazing material is interposed between the first and second panes. Exemplary assemblies can include three or more panes. The assembly can further include an inert gas. In some cases, the transparent glazing material is a free-standing transparent glazing material.

In accordance with yet further embodiments of the disclosure, a method of forming a transparent aerogel and/or an assembly is provided. An exemplary method of forming a transparent aerogel includes forming cellulose nanofibers having an average diameter of less than 10 nm and an average length greater than 100 nm, functionalizing the cellulose nanofibers with carboxylate anions to form functionalized cellulose nanofibers, forming a hydrogel from a network of the functionalized cellulose nanofibers, forming an aerogel from the hydrogel, and silanizing a surface of the functionalized cellulose nanofibers. In accordance with examples of the disclosure, the step of silanizing the surface comprises vapor-phase silanization of the aerogel. In some cases, the step of silanizing the surface comprises silanization of the functionalized cellulose nanofibers of the hydrogel. In accordance with further examples, the step of silanizing the surface comprises exposing the surface to a chlorine-free silanizing agent (e.g., using a silane, such as SiH4 or a higher order silane or an organo-silicon compound). In accordance with further examples, the transparent aerogel is formed on a surface of a rollable substrate. In such cases, the substrate and the transparent aerogel are/can be rollable in a roll having a diameter of less than about 1 centimeter.

It will be appreciated that elements in the figures are illustrated for simplicity and clarity and have not necessarily been drawn to scale. For example, the dimensions of some of the elements in the figures may be exaggerated relative to other elements to help understanding of illustrated embodiments of the present disclosure.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates SiCellA-based window retrofits and IGUs in accordance with examples of the disclosure. a, b, Schematic drawings of a window retrofitted with a SiCellA film (a) and an IGU with a SiCellA film inserted between glass panes (b). c, Square-meter, 1.5 mm-thick SiCellA with 99.2% porosity adhered to an optically clear plastic film. d, e, Photos of a 36 cm×51 cm (d) and a square-meter (e) double-pane IGUs with a LoĒ-366 coating on one glass pane and a 3 mm-thick SiCellA film attached to a surface of the other glass pane. Note that the slight coloring in d and e comes from a LoĒ-366 coated glass used in these IGUs. f, Single pane window retrofitted with a 72.1 cm×71.4 cm SiCellA 1.5 mm-thick film (pointed by an arrow and outlined by a dashed line) and photographed from outside with both a regular photo camera (left) and a thermal imaging camera (right) in a building on the University of Colorado campus. Temperature is coded according to a color scale. g, h. Infrared thermal imaging photos of different types of fenestrations mounted in the openings of 0.78 m×0.68 m×0.43 m hot (g) or cold (h) box with the inside temperature set at 40° C. (g) and −20° C. (h): “SiCellA-IGU” marks a double-pane IGU with a SiCellA aerogel film; “IGU” marks a double-pane IGU without SiCellA; “Retrofit” marks a single 3 mm-thick glass pane retrofitted with a SiCellA film; “Single pane” marks a single 3 mm-thick glass pane.

FIG. 2 illustrates fabrication of superhydrophobic silanized cellulose aerogels at window scales. a, Gelation of a square-meter gel followed by solvent exchange in a 40 L bath. Red 3 mm-thick rubber spacers constitute borders of a flat mold. b, c, Square-meter hydrogel film atop a supporting white mylar sheet photographed before rolling into a roll for drying in a critical point dryer (b) and an ensuing tightly rolled 3 mm-thick SiCellA film on a top of a mylar sheet after drying (c). d, e, 3-mm-thick hydrogel (outlined by a dashed line) shown in b floating in water (d) and the corresponding 3-mm-thick aerogel (outlined by a dashed line) after drying. f, Schematic of the vapor-phase silanization of the aerogel. g, Infrared transmission spectra of unmodified and modified aerogels, with a carboxylate at 1712 cm⁻¹ highly diminished in the aerogel after the surface modification. h, A photo of a water droplet on a SiCellA film's surface with a contact angle 155° measured and marked on the image.

FIG. 3 illustrates nanoscale morphology of aerogels in accordance with examples of the disclosure. a, b, TEM images of ultrasonicated TEMPO-oxidized individual cellulose nanofibers in aqueous dispersions negatively stained with 1% phosphotungstic acid (a) and an unmodified nanocellulose aerogel (b). c, d, TEM image of a silanized aerogel (c) and corresponding tomographic TEM visualization of a SiCellA (d). e, Density of modified and unmodified aerogels depending on porosity. Red line is a guide to the eye. f, N₂ adsorption and desorption isotherms for modified and unmodified aerogels at 77 K. Solid lines connect measured data represented by symbols. The inset shows a distribution of a differential pore volume depending on a pore width for a modified aerogel. g, Distribution of a differential pore surface area depending on a pore width for SiCellA. The inset shows a cumulative surface area depending on a pore width. h, Schematic diagram of a SiCellA formed by a network of thin cellulose nanofibers with silanized surfaces.

FIG. 4 illustrates optical properties of SiCellA materials. a, b, Visible-range spectral dependence of total and diffuse transmittance of 1 mm-thick film shown in the inset (marked by a dashed line) (a) and SiCellA films of different thickness (b). The inset in b shows the transmittance and haze depending on SiCellA film thickness with experimental data points represented by symbols with error bars and solid lines are guides to the eye. c, Triangular SiCellA prism with a thickness of 5 mm. d, Spectral dispersion of a refractive index as calculated from absorption measurements using the Kramers-Kronig relations. Dashed lines mark a refractive index of 1.0025 determined at 632 nm by measuring a minimum deviation angle of a laser beam. e, Visible through near infrared spectral dependence of transmittance and extinction coefficient for a 2 mm thick SiCellA film shown in the inset. f, 25 mm thick SiCellA prism with a 532 nm laser beam passing through without deviation because of its refractive index being close to that of air. g-j, 4 mm-thick SiCellA prisms with shapes of a star (g), a pentagon (h), a hexagon (i) and an octagon (j).

FIG. 5 illustrates thermal properties of SiCellA. a, Temperature dependence of thermal conductivity of SiCellA at different porosities. Solid lines are guides to the eye. b, Thermal conductivity dependence on SiCellA porosity at 5° C. and 25° C. The inset shows a dependence of R per inch on porosity of SiCellA. Symbols with error bars show experimental data points. c, Infrared thermal images of SiCellA films of different shape placed on a hot plate: (from top left to bottom right) 4 mm-thick triangle, square, pentagon, hexagon, heptagon, star. University of Colorado logo, 8 mm-thick triangle, 10 mm-thick disk and rectangle. d, e, Raw infrared transmittance (d) and averaged infrared transmissive emittance weighted by 300 K black-body radiation (e) of unmodified cellulose-based aerogels at various thicknesses (solid lines). For comparison, spectra for silanized and unmodified aerogels of the same 2.5 mm thickness are provided.

FIG. 6 illustrates mechanical properties of cellulose-based aerogels. a, Tensile stress-strain dependence of silanized (solid lines) and unmodified (dashed lines) aerogels with different porosities. The inset shows a SiCellA sample held between tensile mechanical clamps during measurements. b, Compressive stress-strain dependence of aerogels with different porosities. The inset shows a SiCellA sample held between compressive mechanical clamps during measurements. c, Compressive cycle loops of 10 cycles, with a number of a cycle represented by colors according to a color scale. The inset shows compressive stress-strain plots for the 1st and 10th cycles. d, e, A SiCellA sample placed on the 3-point clamps (d) and 3-point bending of the SiCellA sample (e). f, Flexural stress-strain dependence for a 25 mm×5 mm×3 mm aerogel sample. g, A photograph of a bent/folded 2 mm-thick aerogel film of 100 mm×100 mm area showing its rubberlike flexibility.

FIG. 7 illustrates durability, stability and condensation resistance of SiCellA and window products. a, Thermogravimetric analysis of silanized and unmodified nanocellulose aerogels showing the percentage of weight loss depending on temperature. The inset shows a DTG analysis of a TGA. b, Differential scanning calorimetry of unmodified and silanized nanocellulose aerogels. c, Dependence of an interior surface temperature on exterior temperature for SiCellA-based window products compared to a single glass pane. T, shows the outside temperature when condensation forms on the interior surface of the glass at an interior relative humidity of 50%. d-f, Optical performance of a triple-pane IGU with a 3 mm-thick SiCellA layer in the middle before and after a chemical fogging test (d), 80-80 durability analysis (e) and 30 days of 500 W ultraviolet irradiation analysis (f). The insets in d-f show respectively a 15 cm×15 cm IGU after the chemical fogging test (d), 10 cm×10 cm IGU after the 80-80 durability test (e) and a 10 cm×10 cm IGU in a chamber under ultraviolet irradiation (f).

FIG. 8 illustrates windows products containing SiCellA. a, U- and R-values for a single pane window retrofitted with SiCellA of varying thickness on a 100-mm-thick supportive substrate attached to a glass pane (inset schematic); lines and symbols respectively show calculated and measured data. b, U- and R-values versus aerogel thickness calculated for a triple-pane IGU of a fixed total thickness of 32 mm and SiCellA used instead of a middle-pane layer and Low-E coating on one of glass panes. c, U- and R-values versus SiCellA thickness calculated for a triple-pane IGU with a SiCellA film in the middle and a 12 mm gap between a glass pane and SiCellA. Solid and dashed lines are calculated for 0% and 16% of average thermal-range infrared transmittance, respectively. d, A photograph of fabricated triple-pane 15 cm×15 cm IGU with 3-mm-thick SiCellA film used as a middle pane and air gaps between glass panes and SiCellA fixed at 12 mm. e, Calculated (lines) and measured (symbols) U and R for a triple-pane IGU shown in (d). f, Calculated R-values for triple-pane aerogel IGUs with 3 mm thick SiCellA film used as a middle pane and two clear glass panes (IGU 1) or one clear glass pane and LoĒ-180 (IGU 2) or LoĒ-366 (IGU 3) coating filled with air, argon and krypton. g, Spectral dependance of total and diffuse transmittance of triple-pane IGUs with 3-mm-thick SiCellA film used as a middle pane. Right-side inset shows photographs of corresponding IGUs. h, Spectral dependence of total visible transmittance of a triple-pane IGU with 3 mm thick SiCellA between two 3-mm-thick clear glass panes and air gaps of 14 mm (1), double-pane IGU with two clear glass panes of 3 mm thickness and 31 mm air gap (2), 3-mm-thick glass pane retrofitted with 2-mm-thick SiCellA (3), 2-mm-thick free-standing SiCellA (4) and air (5).

FIG. 9 illustrates retrofit products based on SiCellA and their properties. a-c Photographs of (a) 15 cm×15 cm. (b) 20 cm×25 cm and (c) square-meter, 1.5 mm thick SiCellA layer on a transparent plastic film. d, A photograph of a 36 cm×51 cm single 3 mm thick glass pane retrofitted with a 3-mm-thick SiCellA film. e, Spectral dependence of transmittance of 1.5 mm thick hydrogel. f, Spectral dependence of transmittance and extinction of 1.5 thick SiCellA film adhered to a transparent polyester film. g, Spectral dependence of visible transmittance for a 1.5 mm thick SiCellA film adhered to a transparent polyester film. Inset shows a single-pane window retrofitted with this SiCellA-polyester composite film with dimensions 72.1 cm×71.4 cm×0.15 cm.

FIG. 10 illustrates SiCellA-enabled IGUs and their visible-range transmittance. a, A square-meter IGU with a 3 mm SiCellA in between plane and LoĒ-180 coated glasses facing the Rocky Mountains. b, Transmission of different studied IGUs. d-f, Photographs of a 36 cm×51 cm double-pane IGUs with 3 mm thick SiCellA in between (d) 3 mm thick clear glass panes, (e) one clear and one LoĒ-180 glasses and (f) one clear and one LoĒ-366 glass panes.

FIG. 11 illustrates processing hardwood pulp to TEMPO oxidized cellulose nanofibers. a, A cottonwood tree in Colorado, USA as a bioresource of pulp. b, Photograph of soft and hard wood pulp used for the production of TEMPO oxidized cellulose nanofibers. c, Chemical structure of cellulose biopolymer molecule with highlighted active hydroxyl groups on each unit. d, Schematic of the cellulose and TEMPO oxidized cellulose nanofibers along with the reaction details. e, Hardwood cellulose pulp in the oxidation chamber. f, Cellulose pulp under TEMPO oxidation assisted with a blender. g, TEMPO oxidized cellulose nanofibers after the first oxidation and blending. h, Cellulose nanofibers under second oxidation for 72 hours at 60° C. i, TEMPO oxidized cellulose nanofibers with 4-10 nm width (FIG. 3a) in a blender after second oxidation. j, 1 L of TEMPO oxidized nanofibers at 1 wt. % in water after sonication with Branson Sonifier for 30 min at 20% amplitude and filtering.

FIG. 12 illustrates exemplary SiCellA fabrication procedures. a, A photograph of 1 L of TEMPO-oxidized cellulose nanofibers in water dispersed at 1 wt. %. b, A photograph of a uniform aqueous dispersion of cellulose nanofibers at 1 wt % supported with glass underneath and 1 cm×0.3 cm rubber spacers on four sides (red color). c, A tank with a hydrogel formed via the acid gelation (0.5 M HCl) followed by washing out of acid traces and solvent exchange of the hydrogel from water to ethanol. d, The ensuing alcogel with ethanol as the solvent. e, Hydrogel-stage silanization with vinyl silane before drying. f, Silanized alcogel in ethanol before CPD drying. g, CPD drying of the alcogel with liquid CO₂ in a drying chamber. h, Vinyl silane modified SiCellA. i, an unmodified nanocellulose-based aerogel. j, Vapor phase silanization of the aerogel with 1H,1H.2H,2H-perfluorooctyltriethoxysilane. k, Fluorosilane-modified SiCellA.

FIG. 13 illustrates transformation of a large alcogel to an aerogel. a, Rolling of the alcogel along with protective layers to be placed into the big CPD chamber shown in (c). Alcogel is safely and gently protected with layers of foams and plastic meshes for rolling and subsequent drying. b, Tightly rolled square meter alcogel before CPD drying. c, A CPD with a 16.5 cm×104 cm cylindrical chamber, suitable to dry square-meter and larger alcogels. d, Tightly rolled CPD dried square meter aerogel. e, Square meter aerogel unrolled after drying, adhered to a transparent plastic film. f, A photograph of square foot rolled aerogels after drying.

FIG. 14 illustrates experimental setup for measuring the thermal properties of IGUs. a, A photograph of a hot/cold box and data acquisition setup measuring thermal performance of a square-meter single-pane window retrofitted with a 1.6 mm thick SiCellA film; the heat flux and temperature sensor are indicated. b, Typical experimentally measured heat flux and corresponding temperatures versus time.

FIG. 15 illustrates a, Brunauer-Emmett-Teller (BET) plots for unmodified and silanized aerogels. b, Isotherm of unmodified aerogel. c, Absolute isotherm of unmodified aerogel. d, Pore size distribution of unmodified and modified aerogels based on density functional theory models. e, Isotherm of modified aerogel. f, Absolute isotherm of modified aerogel.

FIG. 16 illustrates a, Stress-strain and b, force-strain plots for the 2% elongation cycles. c, Stress-strain and d, force-strain plots for the 4% elongation cycles.

FIG. 17 illustrates a, Stress-strain plots for the 2% compression cycles; the inset shows an alcogel-stage sample and the characterized aerogel on the compression pan. b, Compression and recovery of the aerogel at 2% strain within 10 cycles. c, Stress-strain plots for the 4% compression cycles. d, Compression and recovery of the aerogel at 4% strain within 10 cycles. e, Stress-strain plots for the 6% compression cycles. f, Compression and recovery of the aerogel at 6% strain within 10 consecutive cycles.

FIG. 18 illustrates thermal images of a thermal radiation source taken through glass or SiCellA. Thermal images obtained by placing a, uncoated glass, b, LoĒ-180 Glass, c, LoĒ-366 Glass and d, SiCellA of 6.5 mm thickness. The images were taken by FLIR E60 camera by using the blackbody radiation source at 40° C. with emissivity ≥0.95: the emitting surface of the used model GM-01A blackbody radiation source (from IKTech Corp) was at 10 mm from the closest surface of glass or SiCellA and the measurements were performed in a vacuum chamber to avoid the heat exchange through conduction and convection of air. The measured surface temperature shows that the thickness-dependent SiCellA slab's ability of blocking radiative heat transfer can be better than that of low-emissivity-coated glass used in the glass industry.

FIG. 19 illustrates an assembly and numerically calculated thermal properties of triple-pane SiCellA IGUs.

FIG. 20 illustrates a three-pane assembly in accordance with further examples of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS

Although certain embodiments and examples are disclosed below, it will be understood by those in the art that the disclosure extends beyond the specifically disclosed embodiments and/or uses of the disclosure and obvious modifications and equivalents thereof. Thus, it is intended that the scope of the disclosure should not be limited by the particular embodiments described herein.

Unless noted otherwise, illustrations presented herein are not necessarily meant to be actual views of any particular material, assembly, structure, or device, but are merely representations that are used to describe embodiments of the disclosure.

To maintain comfortable indoor conditions, buildings consume ~40% of the energy generated globally. Windows and skylights are the least efficient parts of the building envelope because achieving simultaneously high transparency and thermal insulation of glazing remains a challenge. Here is described transparent cellulose-based aerogels (glazing materials) fabricated from the Earth's most abundant biopolymer by utilizing approaches like colloidal self-assembly and roll-to-roll processing. With visible-range light transmission of 97-99% (better than glass), haze of ~1% and thermal conductivity lower than that of still air, the cellulose-based aerogels are suitable for scalable manufacturing. These lightweight materials, with mass density hundreds of times lower than glass, can be used both as panes inside multi-pane insulating glass units and for retrofitting of existing windows. Exemplary aerogels boost energy efficiency and enable entirely new technical solutions for insulating glass units, skylights, daylighting and facade glazing, potentially increasing the role of glazing in future building envelopes.

### SPECIFIC EXAMPLES

Specific examples are provided below. The examples below are merely exemplary and illustrative. Unless noted otherwise, the examples are not to be viewed in a limiting sense. Similar methods and materials can be used for other plasmonic nanoparticles, nematic liquid crystal, functionalized coatings, and/or chemical coatings described herein.

### Fabrication of Nanostructured SiCellA Materials for Insulation at Window Scales

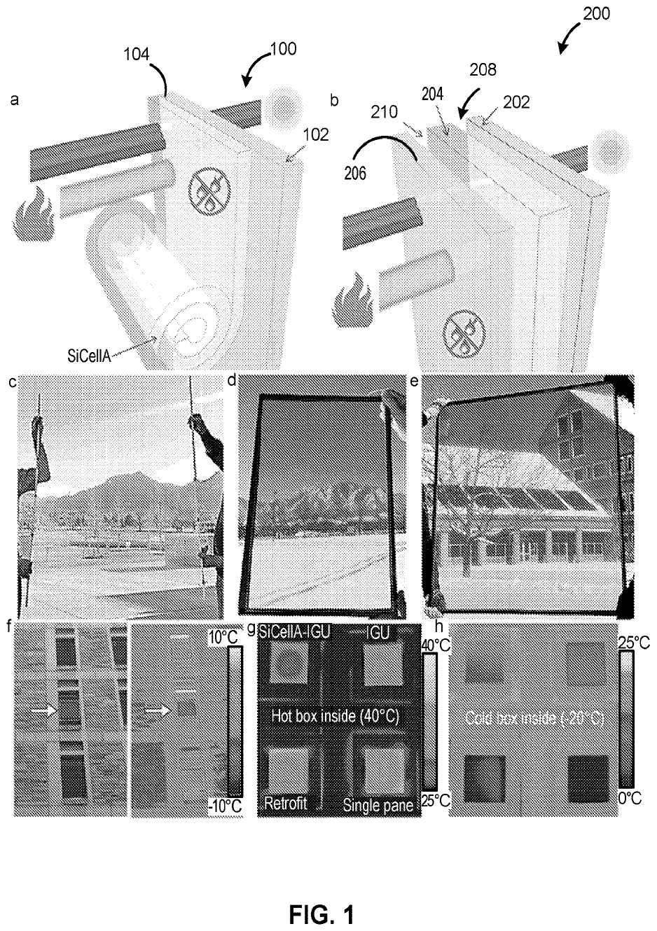

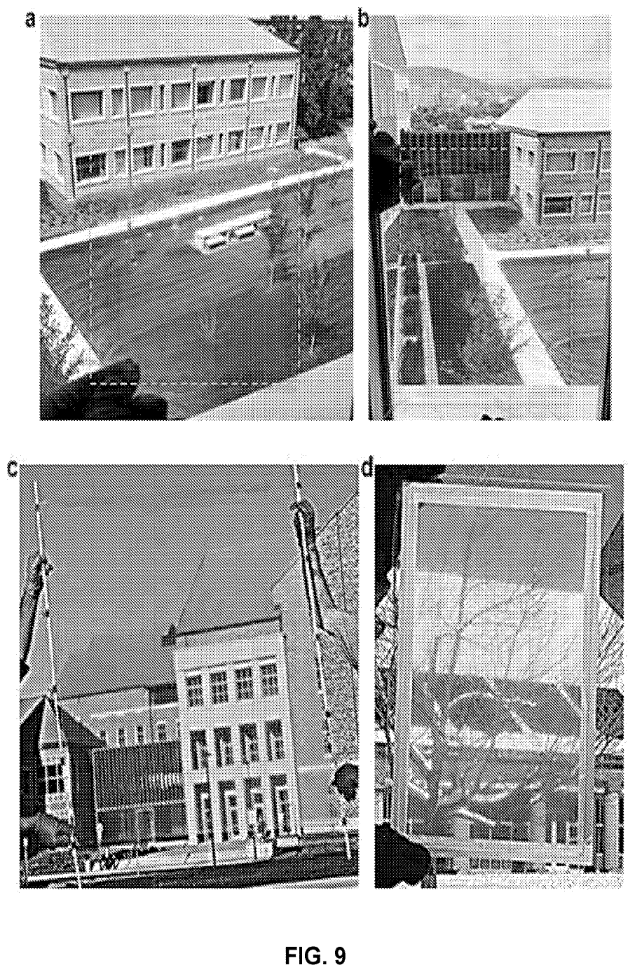

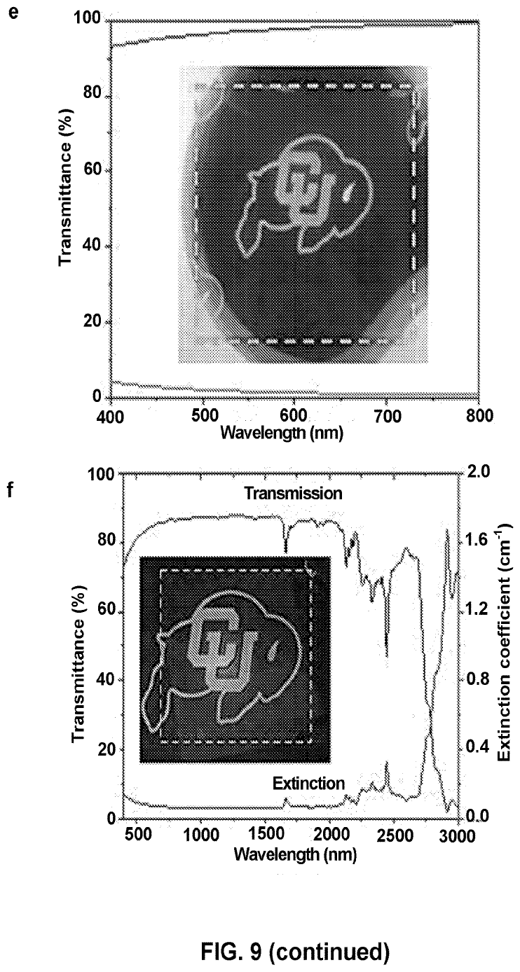

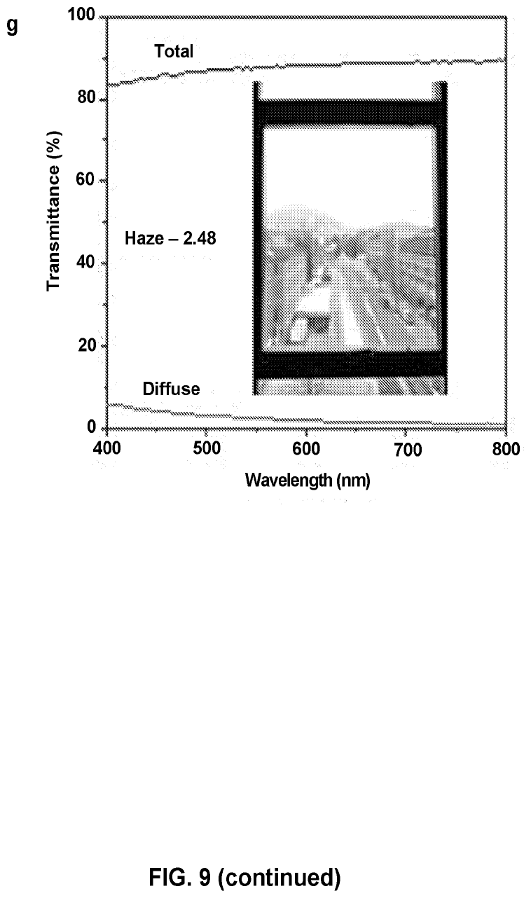

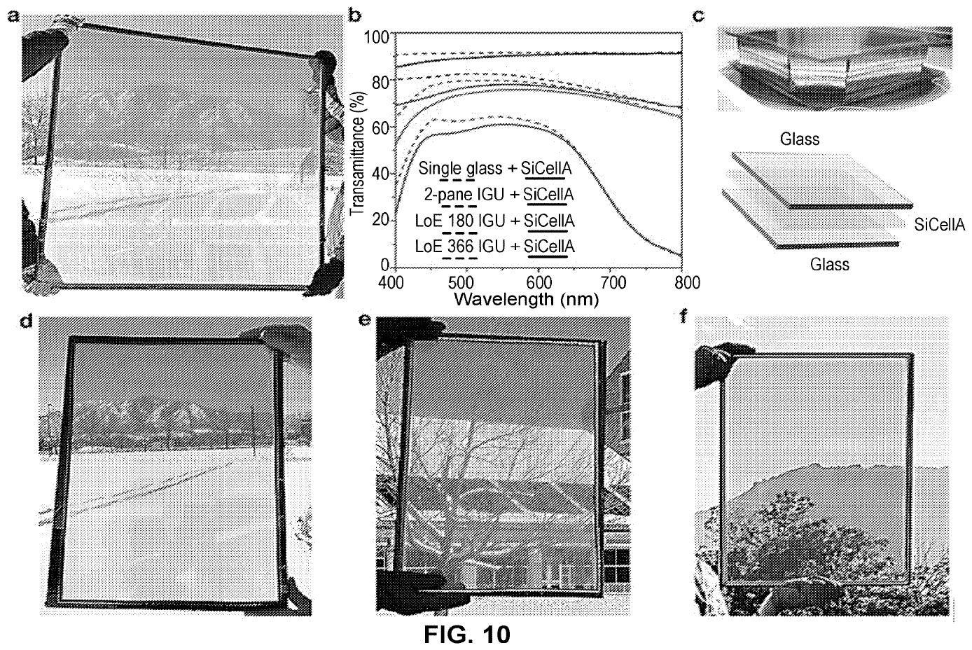

Transparent, thermally super-insulating SiCellA materials can boost efficiency of pre-existing windows and enable new window products (FIG. 1 a, b), as demonstrated using SiCellA-based retrofit films and IGUs at window-relevant scales (FIG. 1 c-e and FIGS. 9 and 10).

FIG. 1 a illustrates an assembly 100 that includes a substrate 102 and a transparent glazing material 104 (e.g., a SiCellA film or simply SiCellA or sometimes aerogel) as described herein. FIG. 1 b illustrates an assembly 200 that includes panes 202 and 206 and a transparent glazing material 204 disposed between panes 202 and 206. As illustrated, a gap 208, 210 can be between transparent glazing material 204 and one or more panes 202, 206.

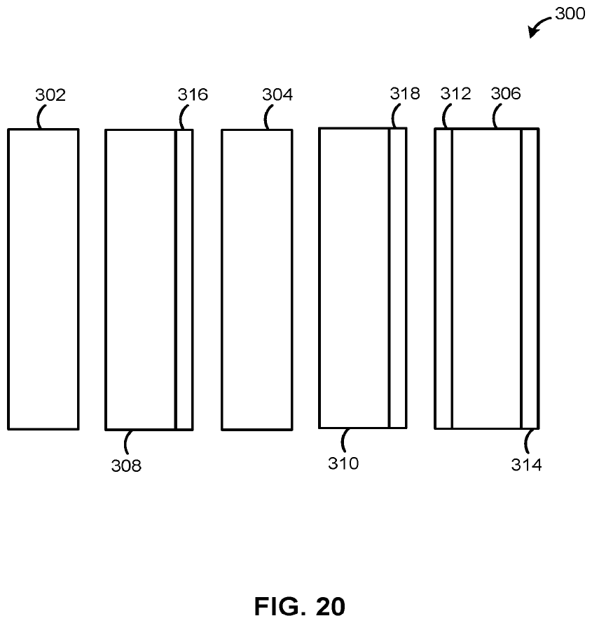

FIG. 20 illustrates a three-pane assembly 300 in accordance with further examples of the disclosure. Assembly 300 can include panes or substrates 302, 304, 306 with one or more transparent glazing materials 308, 310 between and/or on panes or substrates 302, 304, 306. In some cases, gaps can be between the panes and the transparent glazing material(s), as described in more detail below. Further, as discussed below. assemblies can include one or more coatings 312-318 on one or more panes and/or on one or more transparent glazing materials.

The SiCellA films (also referred to herein as transparent glazing material—e.g., transparent glazing material 104, 204) readily adhere to the surfaces of a substrate, such as substrate 102 and/or panes 202, 206, which can be formed of, for example plastic films and/or glass panes due to electrostatic charge. A thin film of SiCellA (FIG. 1 c) allows for boosting the thermal barrier performance of a single-pane window when used as a retrofit laminated on its inner surface, as vividly revealed by thermal imaging of the exterior glass surface temperature during winter (FIG. 1 f). A temperature of the retrofitted pane's outer surface is measured to be lower than that of similar panes without retrofits because of more effective blocking of the heat transfer through the window enabled by the installation of a SiCellA retrofit (FIG. 1f). Hot and cold boxes that mimic an interior-exterior heat exchange during summers and winters, respectively, illustrate similar superior thermal barrier performance enabled by SiCellA aerogels described herein when laminated atop of single-pane glass or inserted into the gap of a double-pane IGU (FIG. 1 g, h).

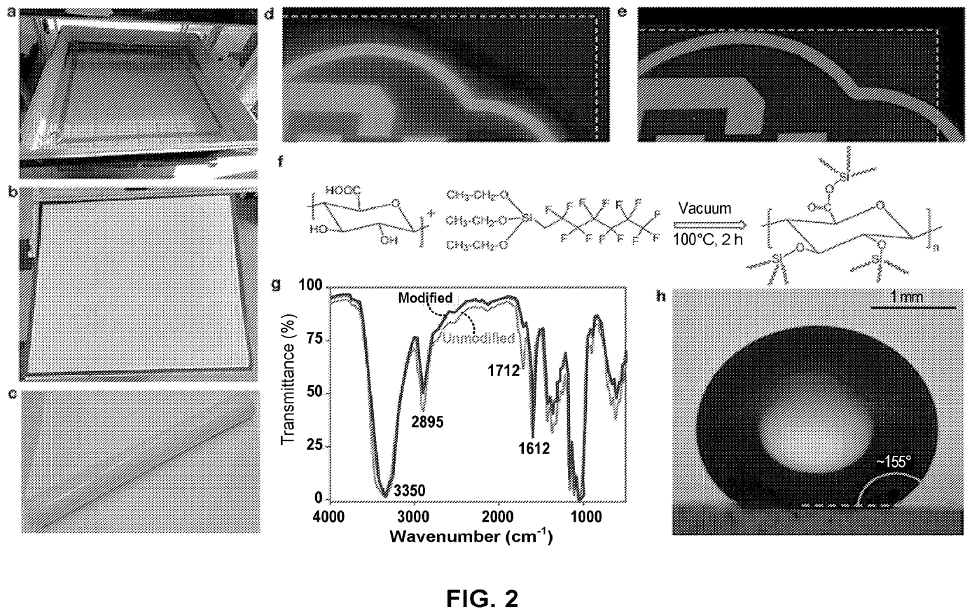

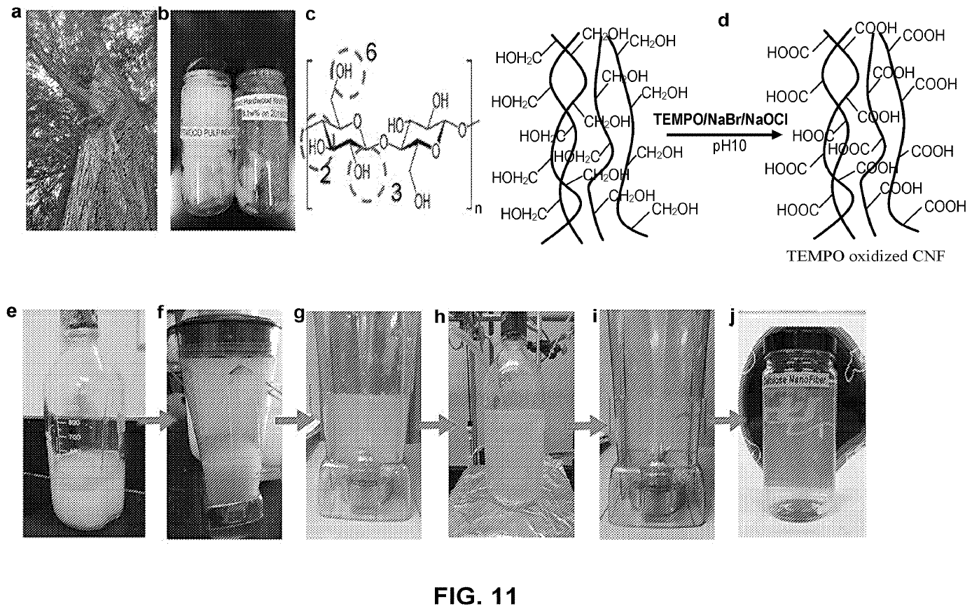

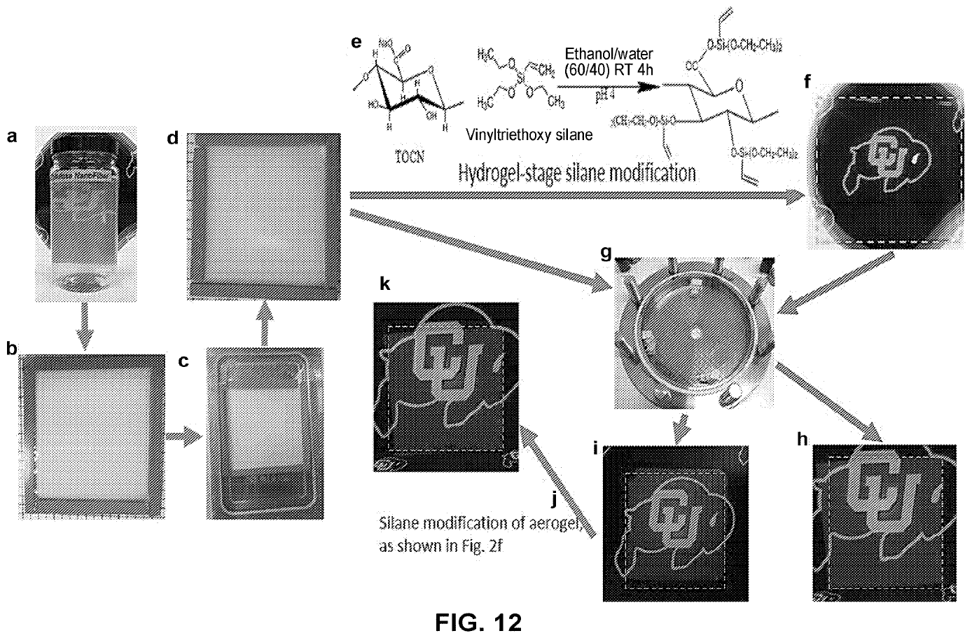

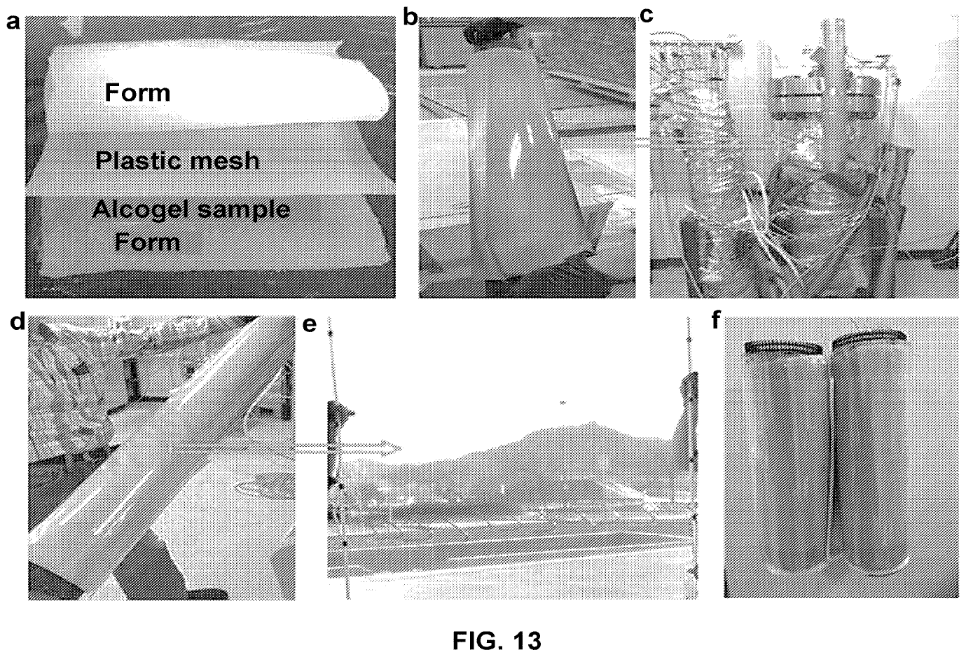

An exemplary method to fabricate SiCellA materials includes processing the wood-pulp-derived cellulose nanofibers or other suitable cellulose nanofibers with an oxidant, such as 2,2,6,6-tetramethylpiperidine-1-oxyl radical (TEMPO)-mediated to obtain oxidation of native cellulose (See FIG. 11). Other exemplary cellulose nanofibers can be obtained by chemical or mechanical treatment of a variety of natural sources, for example, cotton, soft wood pulp, hard wood pulp, tunicate and bacterial cellulose and the like. In some cases nanorods and nanofibers can be obtained from multiple sources, such as any combination of the above sources. The surface charges associated with the carboxylate anion mitigate the nanofiber aggregation and allow the nanofibers to form stable aqueous colloidal dispersions at varying concentrations, which can be poured into molds of desired shapes and sizes (See FIG. 12). Adding acid (such as HCl acid or HF) inter-links the nanofibers via hydrogen bonds between the carboxyl groups, transforming the colloidal dispersion into a hydrogel with a network of sparce nanofibers (FIG. 12 b). Next, the fluid medium is exchanged within the gel, by replacing water with isopropanol or ethanol (see FIG. 2 a, b and FIG. 12 c, d), and the gel is then, e.g., super critically dried to form an aerogel (FIG. 2 c). These fabrication procedures are highly scalable (FIG. 2 a-c), combining simple steps like molding to define the volume of the desired hydrogel, solvent exchanges at modestly elevated temperatures (see FIG. 12), and rolling and drying the gels in rolls. Moreover, such techniques allow for mitigation of aggregation of cellulose nanofibers during gelation or drying, so that initially transparent colloidal dispersions remain transparent in hydrogel and aerogel states (FIG. 2 d, e, FIG. 13). In accordance with examples of the disclosure, cellulose surfaces are silanized, which can be done by vapor phase functionalization (FIG. 2f) after the supercritical drying and/or at the hydrogel stage, before drying, with details of both approaches provided below, see, for example, FIGS. 2f and 12 e-k. While the silanization is revealed by infrared spectroscopy through analyzing presence or strength of certain absorption lines (FIG. 2g), this procedure makes the SiCellA superhydrophobic in nature (note the water droplet's contact angle >150° revealed in FIG. 2h), a highly desirable property for window applications.

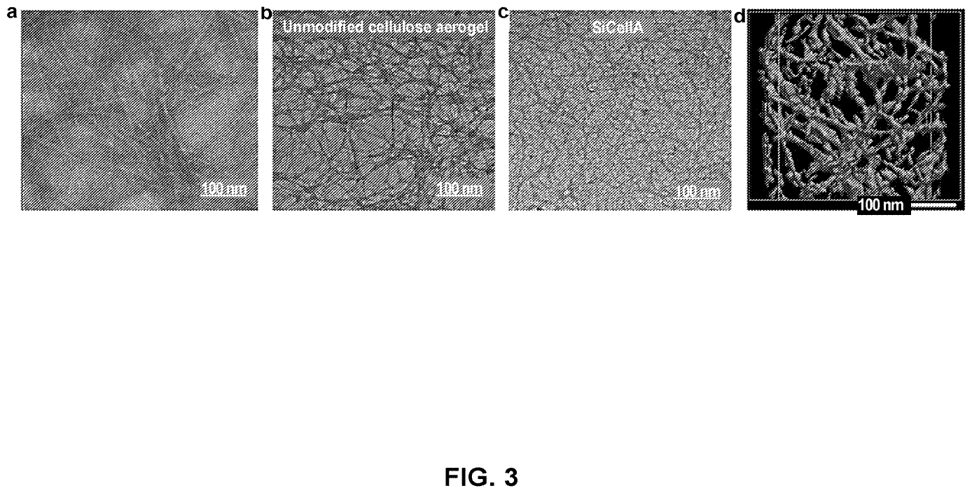

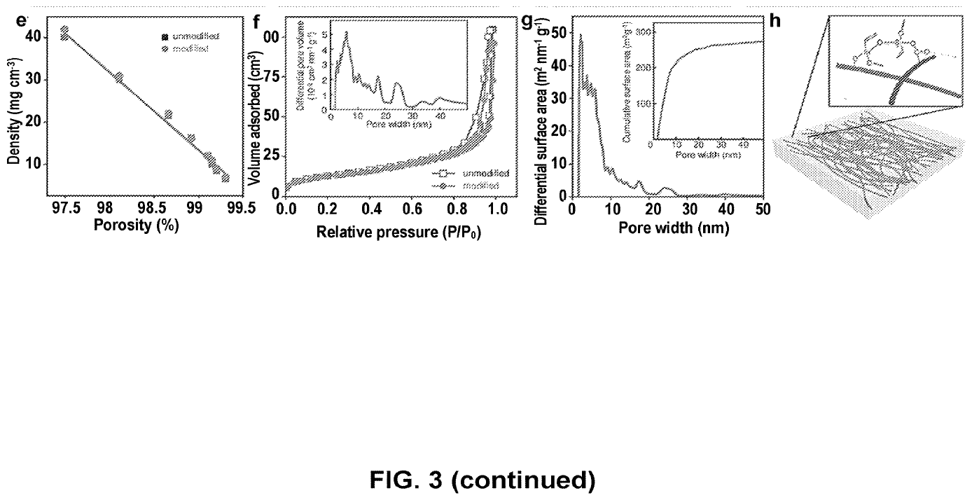

Nanoscale characterization provides insights into the formation and structure of SiCellA materials (FIG. 3). In accordance with examples of the disclosure, individualized cellulose nanofibers are well defined rodlike particles with 4-6 nm width or other widths noted herein and hundreds-to-thousands nanometers length as, for example, noted herein (FIG. 3 a). The fabrication procedures of gelation, surface modification, solvent exchanges and drying transform the initial colloidal dispersions of such nanorods into gels with nanoscale morphology featuring networks of thin fibers, with inter-fiber pores typically smaller than 100 nm (FIG. 3 b-d). By controlling the initial concentration of cellulose nanofibers, one can vary porosity of SiCellA, in the range from 97.5% to 99.25% or 90% to 99.5% (FIG. 3 e), which is linearly related to mass density of the material.

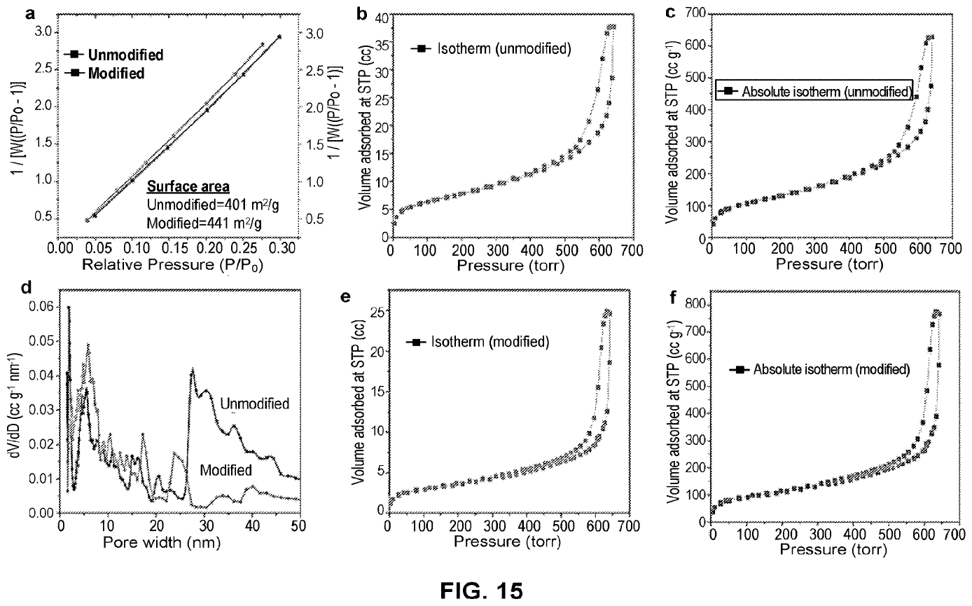

Nitrogen absorption-desorption analysis is consistent with the direct nanoscale imaging, yielding a quantitative analysis of SiCellA's porous morphology (FIG. 3f,g, FIG. 15) associated with a network of inter-linked nanofibers (FIG. 3 h).

### Optical, Thermal and Mechanical Properties of SiCellA Materials

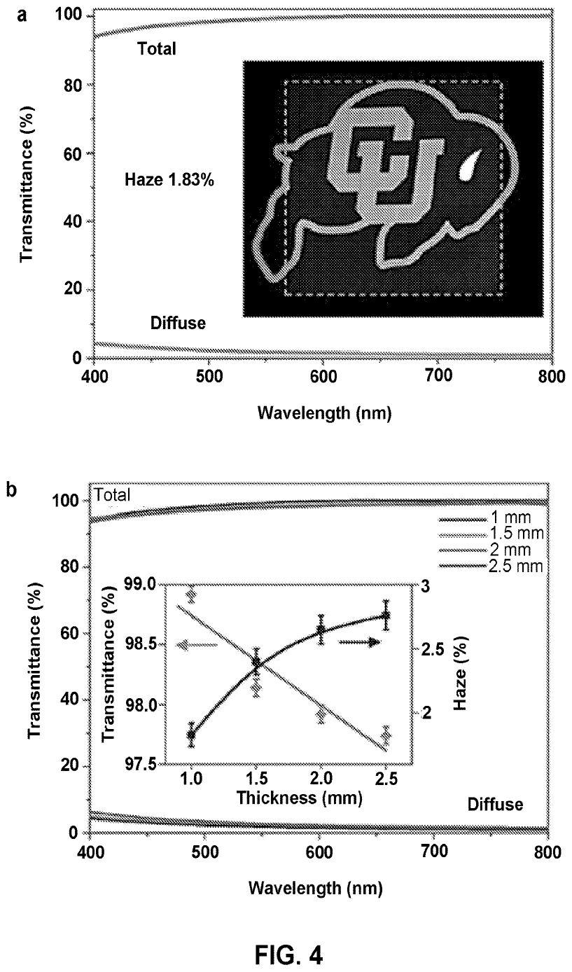

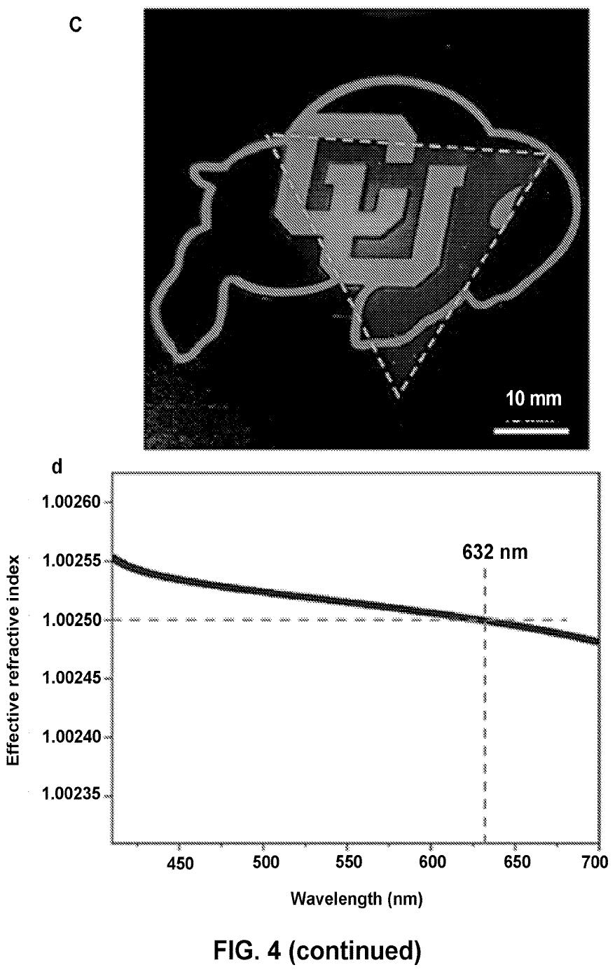

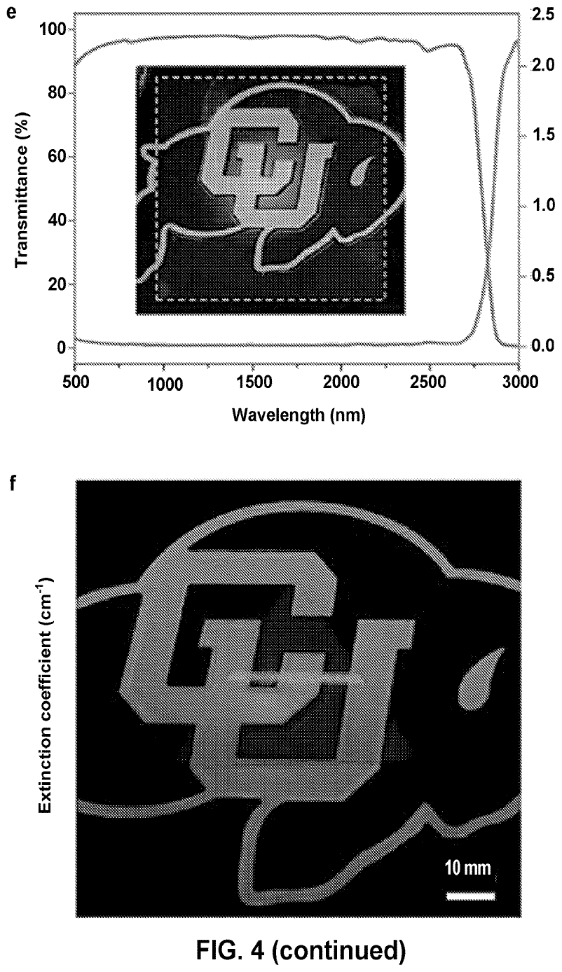

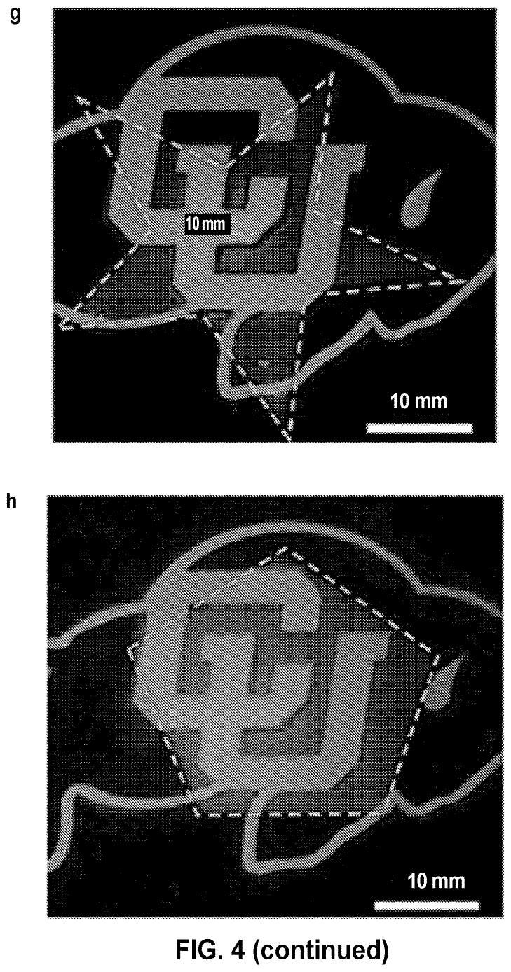

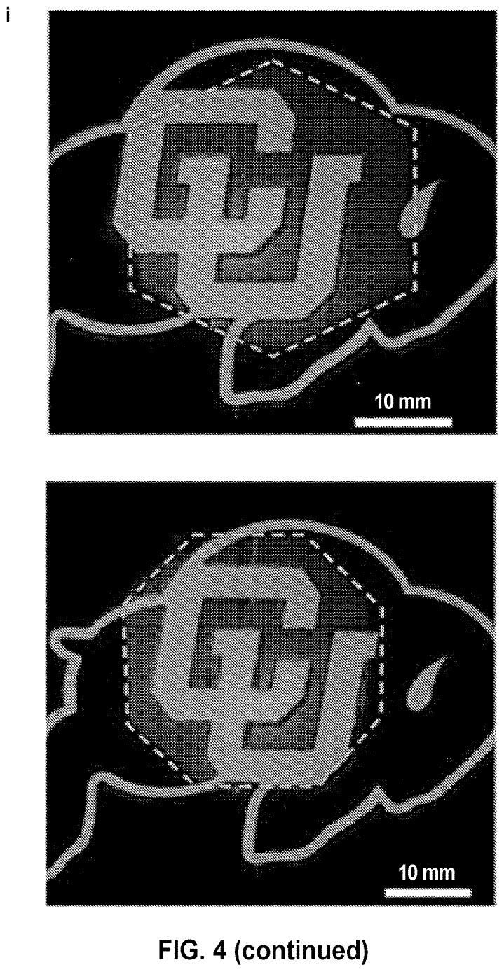

While serving their primary functions enabled by transparency, modern windows and skylights are expected to effectively separate the controlled indoor environment from a building's exterior. Transparent SiCellA materials as described herein exhibit a desired combination of optical, thermal and mechanical properties that makes them suitable for applications in window products. An exemplary free-standing slab of SiCellA features very high visible-range transmissivity, within 97-99%, much higher than that ~92% of glass (FIG. 4 a-c, FIG. 9 and Table 1).

TABLE 1

| | | Total average | |
|---|---|---|---|
| | | visible | |
| | | transmission, % | Haze, % |
| Triple-pane IGUs | with clear glass | 74.3 | 1.2 |
| with SiCellA as the | with clear glass | 74.1 | 1.2 |
| middle pane | and LoĒ-180 | | |
| | coating | | |
| | with clear glass | 43.2 | 1.3 |
| | and LoĒ-366 | | |
| | coating | | |

| | | |
|---|---|---|
| Clear glass retrofitted with SiCellA | 90.0 | 2.9 |
| 1 mm thick SiCellA | 98.9 | 1.8 |
| 1.5 mm thick SiCellA | 98.1 | 2.4 |
| 2 mm thick SiCellA | 98.1 | 2.5 |
| 2.5 mm thick SiCellA | 97.9 | 2.7 |
| Double-pane IGU without SiCellA | 78.2 | 0.4 |
| 3 mm thick LoĒ-180 glass | 84.0 | — |
| 3 mm thick LoĒ-366 glass | 51.0 | — |
| 3 mm thick clear glass | 91.0 | — |

Additionally, the haze coefficient is low, typically within 1-3%, depending on the thickness of the SiCellA slab (FIG. 4 a, b). Low-scattering, highly transparent slabs of varying thickness can be made (FIG. 4 b). This very high optical transparency stems from the nanoscale nature of SiCellA (FIG. 3), where all length scales of aerogel morphology are much smaller than the wavelength of light in the visible spectral range. The very high porosity of SiCellA, with the content of the solid being only ~1% and that of air ~99%, makes the effective refractive index of these materials and air being close (FIG. 4 d). Because of this low refractive index of about 1.0025 (compare that of air ~1.0003 and glass ~1.52), the SiCellA-air interfaces reflect much less light than glass-air interfaces, so that SiCellA's light transmission is high throughout the visible and near infrared spectral ranges (FIG. 4 a-c, e). Because of the index-matching properties of SiCellA and air, prisms of these materials exhibit very small deflection angles while light follows the Snell's law at the aerogel-air interfaces (FIG. 4 f). The color rendering index, which quantifies impact of a material or a window on perception of natural colors, is very high, ~99%, so that the natural colors are preserved. Furthermore, SiCellA materials can be cut to desired shapes using, for example, a regular razor or knife, while retaining high transparency (FIG. 4 c, f), and/or can be molded to adopt a large variety of geometric shapes and dimensions from millimeters to meters while preserving low haze and high transparency (FIGS. 1 and 4 g-j).

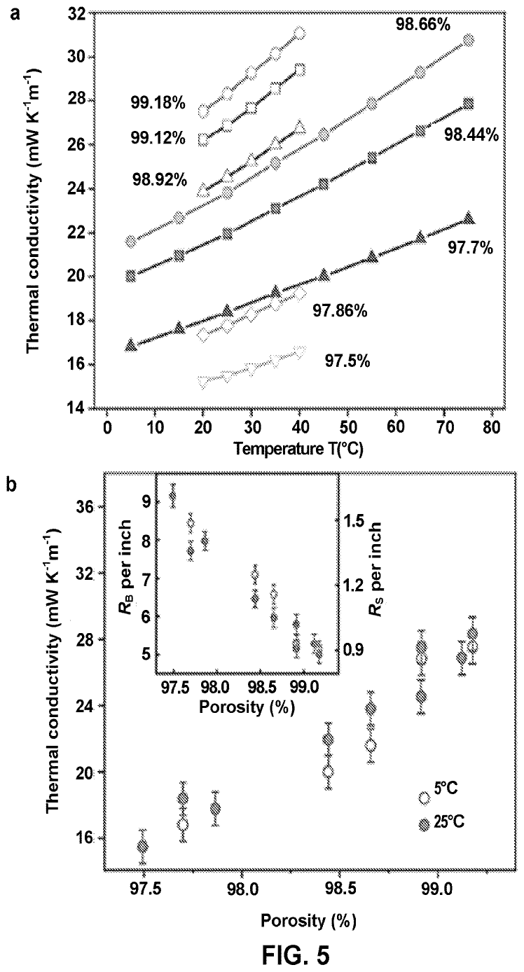

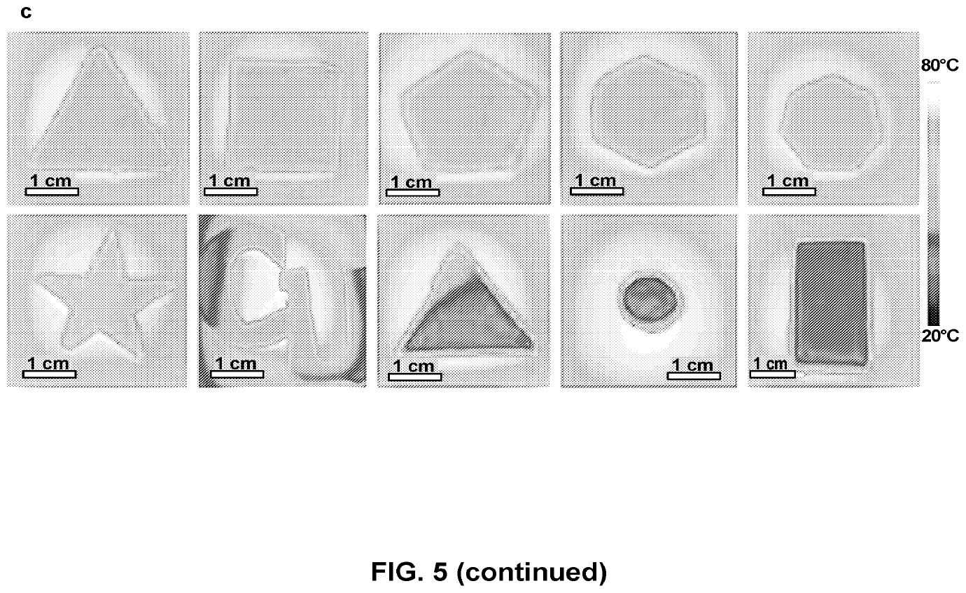

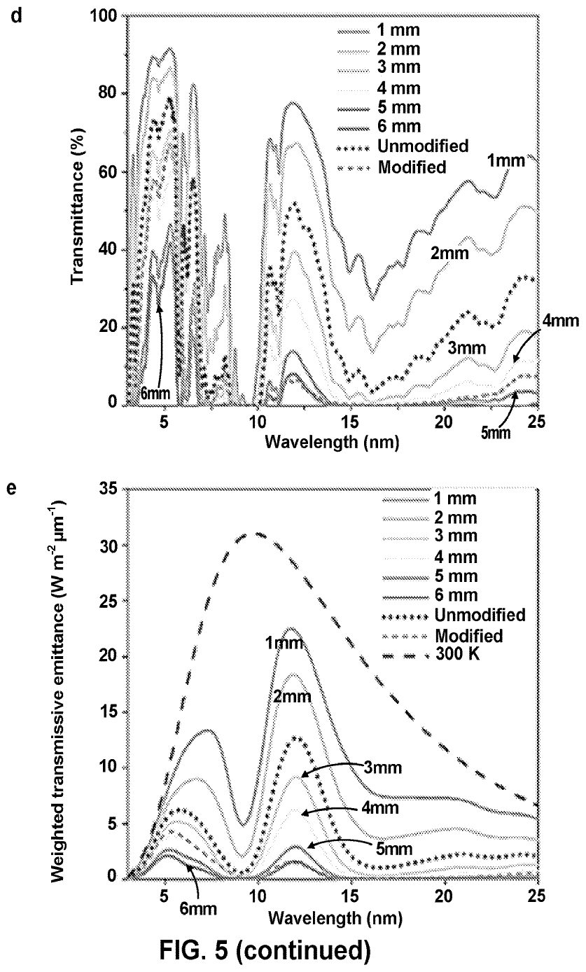

While minimally affecting the visible light transmission (FIG. 4), SiCellA can serve as excellent thermal barriers (FIG. 5), capable of boosting the window's heat transfer resistance R and reducing the U-factor measuring how well a window insulates. U=1/R. The transparent glazing material's thermal conductivity and R depend on porosity, as well as vary with temperature (FIG. 5 a, b). For appropriately selected porosities, SiCellA significantly outperforms thermal barrier properties of still air, and its performance does not suffer from convection-related problems characteristic for air and other gas fillers, as discussed below in the contexts of window products. A vivid demonstration of excellent thermal insulation is obtained by placing the slabs of aerogel of different thicknesses and shapes atop a hot stage (FIG. 5 c). The nanoscale morphology of SiCellA is such that the molecules of air collide more often with the cellulose network than with each other, so that the gas thermal conduction is greatly reduced as compared to that of bulk air, whereas the poor thermal contacts between fibers of the cellulose network minimize the thermal conduction through the (about 10% by volume) solid component. In addition to these two factors and low thermal conductivity measured, differently from air, exemplary transparent glazing materials described herein obstruct transmission of thermal-range radiation, so that the radiative heat transfer is also reduced (FIG. 5 d, e). Exemplary transparent glazing materials based on pristine cellulose are somewhat transparent in parts of the thermal range, but silanization of their surfaces significantly reduces this transparency (FIG. 5d), thus further boosting the thermal barrier properties of the transparent glazing material, as quantified using transmissive emittance weighted over the spectrum of thermal black body radiation at room temperature (FIG. 5 e). Although many aerogels can exhibit rather low thermal conductivity, SiCellA uniquely combine this property with very high visible transparency and low haze, as desired for window applications. SiCellA aerogels (transparent glazing materials) are optically anisotropic (birefringent, with the difference between extraordinary and ordinary refractive indices ~4×10⁻³) because they are prepared through gelation of nematic colloidal dispersions of oxidized cellulose nanofibers. Although not directly relevant to window applications, birefringence reveals polydomain and monodomain nematic-like structures of nanofiber organization with slow spatial changes of nanofiber orientations, which is desired to maintain spatially homogeneous distribution of the effective refractive index and reduce light scattering associated with such variations.

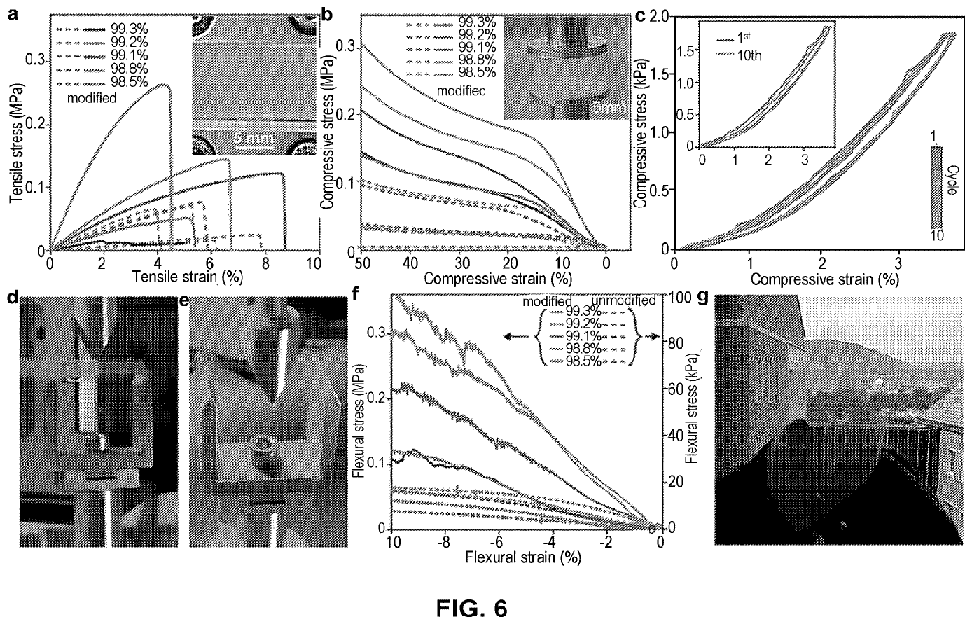

While poor mechanical stability of conventional aerogels hinders many technological uses, SiCellA materials are mechanically robust with properties partly boosted by the silanization (FIG. 6). Compressive and flexural deformations reveal that such materials can withstand significant mechanical loads anticipated during manufacturing and service of various window products (FIG. 6 a-f). Periodic cycles of compression reveal no detectable degradation of mechanical performance with time (FIGS. 6 c, 16, and 17). The films and slabs of SiCellA of millimeter-to-centimeter thickness can be bent and even rolled (FIG. 6 c-g) while retaining high transparency, exhibiting no cracks or degradation of performance. Since the mechanical properties are porosity-dependent, the desired mechanical behavior can be also tuned by preparing samples with different porosities and solid contents (FIG. 6 a, b, f).

Window Products and their Durability

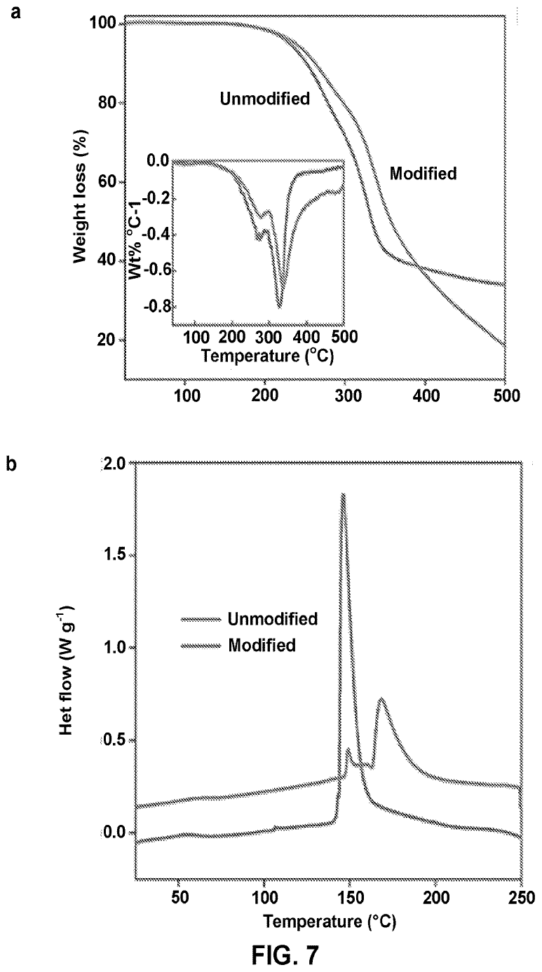

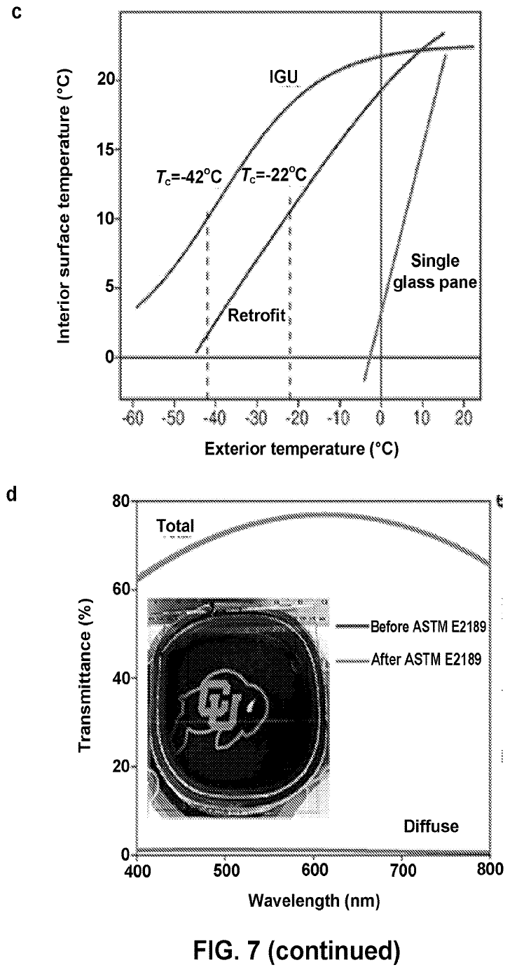

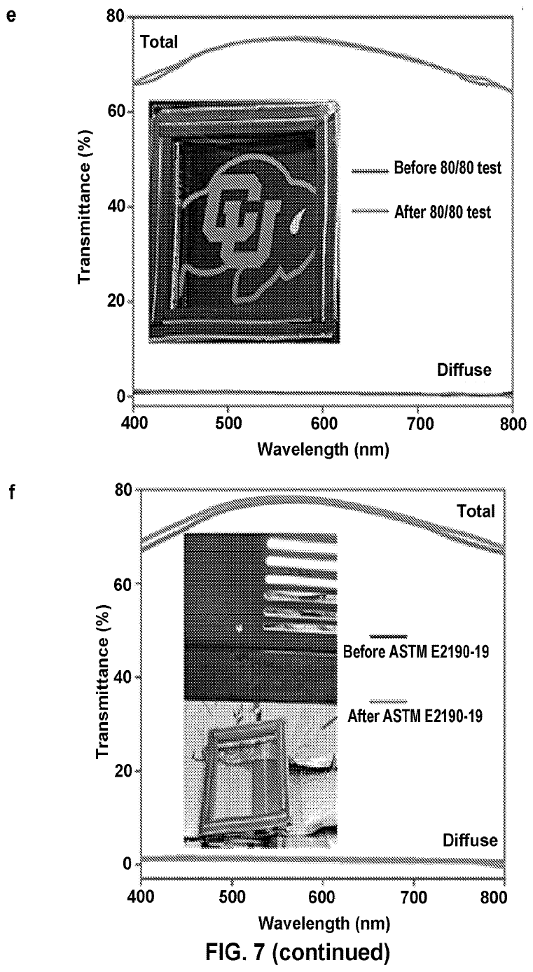

There are many stringent desired properties for window applications that go well beyond the optical, thermal and mechanical characterizations described above. Some of the desired properties relate to durability of materials themselves, as well as the overall glazing products in which these materials are used. The thermogravimetric analysis (TGA), derivative thermogravimetric (DTG) and differential scanning calorimetry (DSC) characterizations of salinized and unmodified cellulose aerogels reveals that they are thermally stable at ambient and modestly elevated temperatures (FIG. 7 a, b). Although heating such materials well above 200° C. can cause degradation, no such high temperatures are relevant to window and skylight applications. The exemplary SiCellA aerogels boost condensation resistance of windows when used both as retrofits and within IGUs (FIG. 7 c), with SiCellA-retrofitted single pane glass showing condensation resistance factor (quantifying the window's ability to resist condensation of water on its surface at low temperatures) comparable to that of commercial double-pane IGUs. A thin double-pane IGU with air filler replaced by a SiCellA shows a condensation resistance factor of 82, much better than that of 35-50 known for commercial double-pane IGUs. SiCellA show no detectable performance degradation after the chemical fogging test of the SiCellA IGU (FIG. 7 d), which is related to its superhydrophobic nature (FIG. 2 h). Fortnight-long 80/80 humidity and ultraviolet exposure tests reveal no significant degradation of optical or thermal properties of the SiCellA IGUs (FIG. 7 e). By performing the standard ASTM2189 and ASTM2190—19 tests with the IGU containing SiCellA within its gap (see FIG. 1 b), no condensation within the IGU's interior was found, as well as no significant changes in light transmission and thermal performance in response to chemical processes or factors like ultraviolet irradiation (FIG. 7 d-f, and Table 2). As envisaged (FIG. 1 a, b), SiCellA significantly boost the condensation resistance of window products, including single-pane windows, upon retrofitting with the aerogel-based film and IGUs upon inserting the aerogel into a double-pane IGU's gap (FIG. 7c).

TABLE 2
Optical properties of the IGUs before and after the
durability tests. Triple-pane IGUs with 3 mm thick
SiCellA in between 3 mm thick clear glasses and overall
IGU thickness 36 mm were used for durability tests.

| | | Total visible | |
|---|---|---|---|
| Test | State | transmission, % | Haze, % |
| Ultraviolet | Before | 74.3 | 1.2 |
| exposure | After | 74.5 | 1.2 |
| Humidity (80- | Before | 74.6 | 1.3 |
| 80) | After | 74.6 | 1.3 |
| Chemical | Before | 73.3 | 1.2 |
| fogging | After | 73.3 | 1.2 |

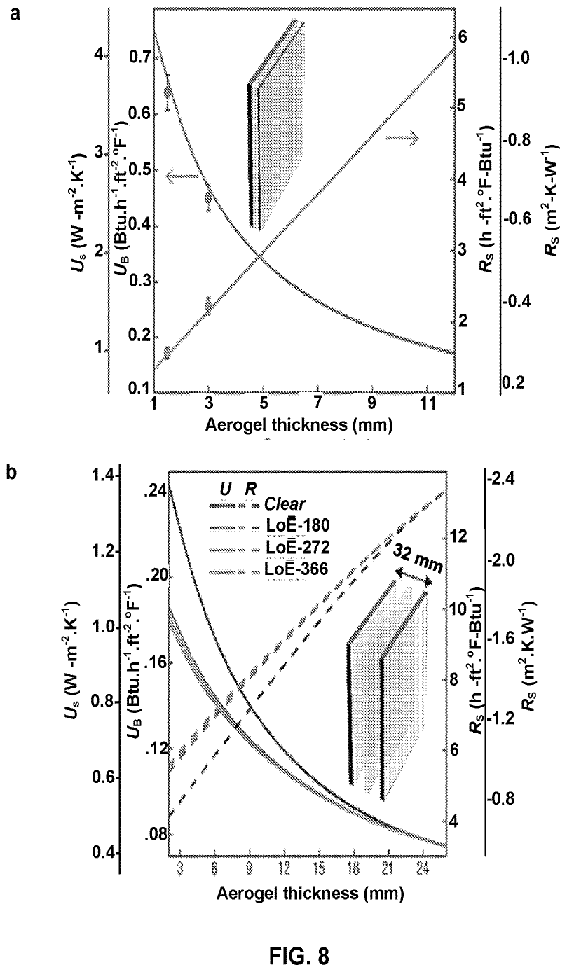

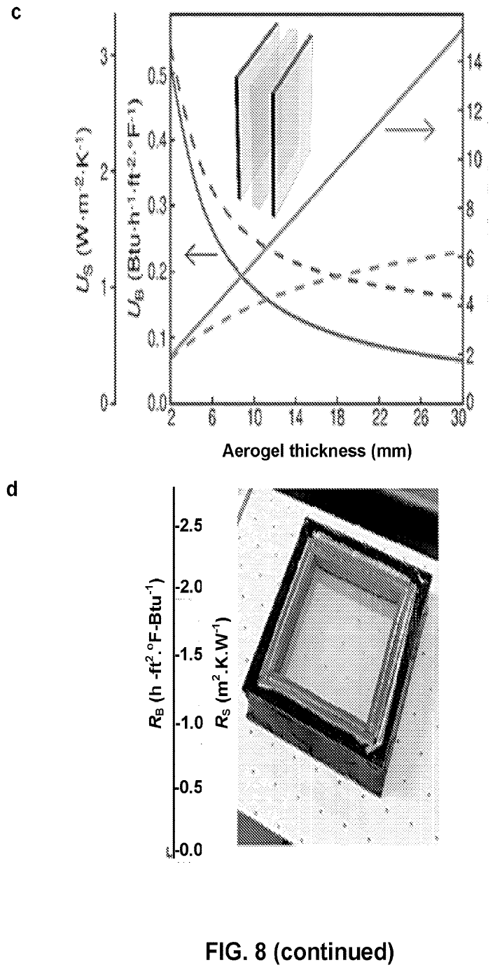

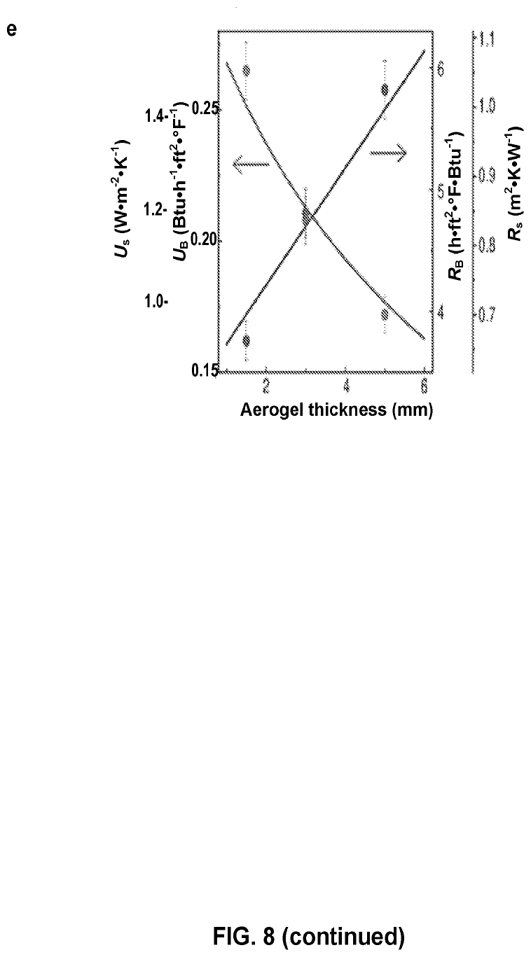

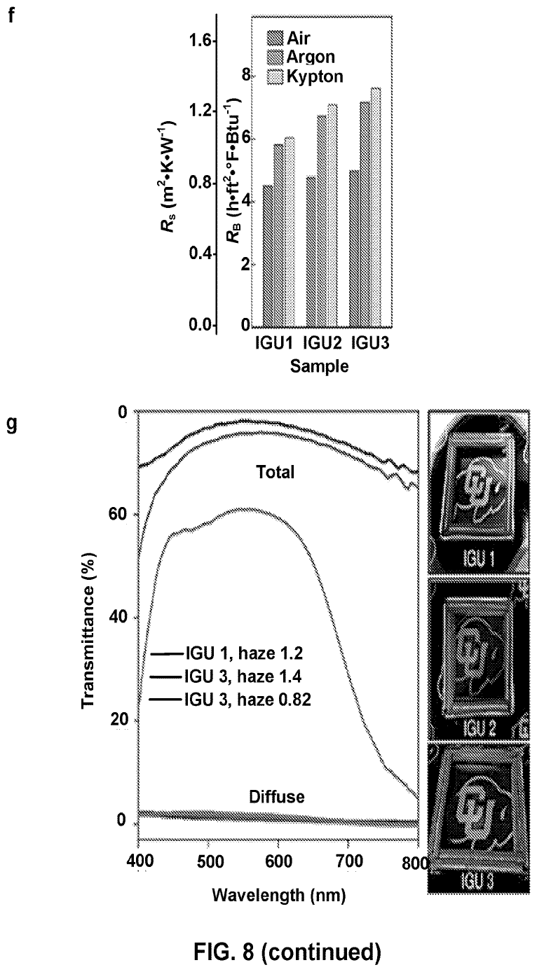

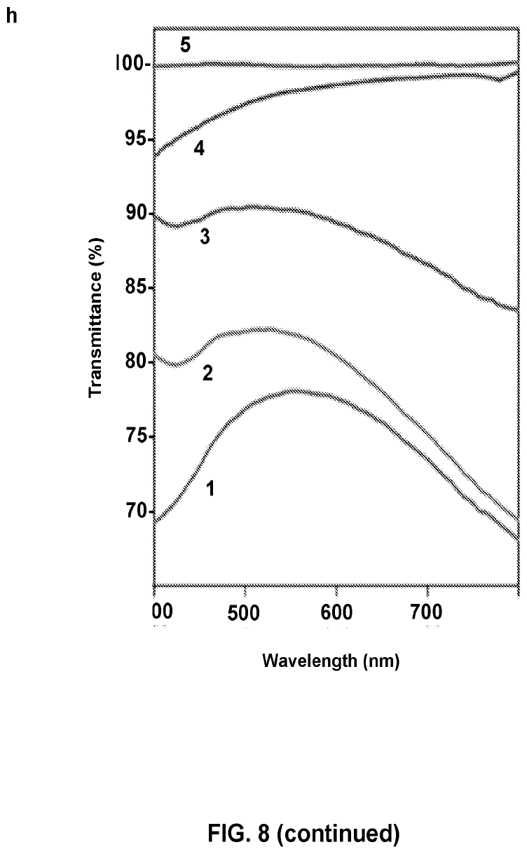

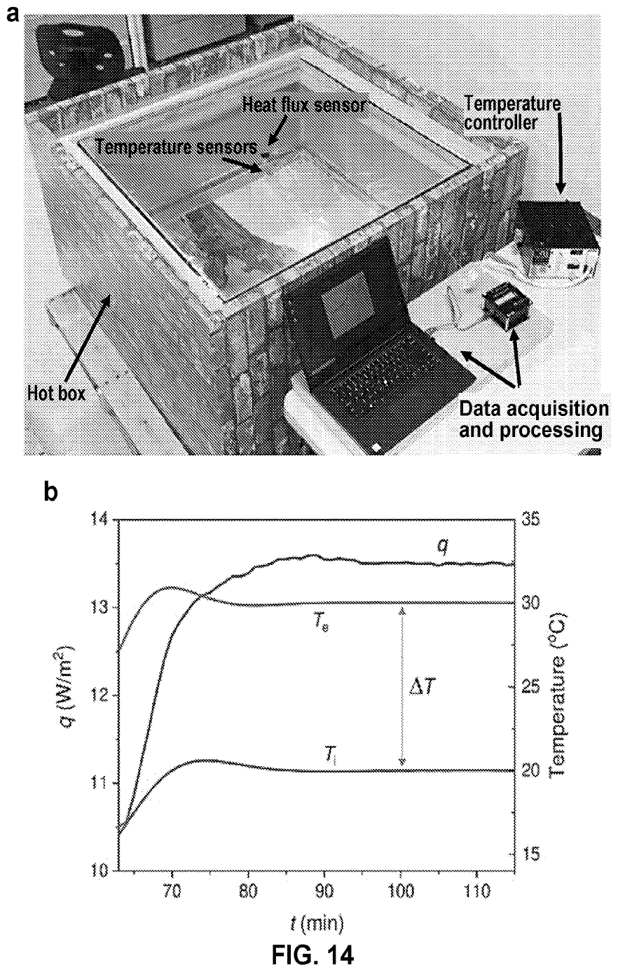

To create a robust retrofit product, exemplary SiCellAs were adhered to protective clear plastic or thin glass substrates, followed by lamination atop of the inner surfaces of single-pane windows (FIG. 1 c, f and FIG. 9). The ensuing R-value of a retrofitted single-pane window then can depend on the SiCellA thickness, as revealed by combining numerical modeling and experimental measurements (FIG. 8 a) that involve both real windows and hot/cold box prototypes (FIG. 1 f-h and FIG. 14). Such boosted-efficiency single-pane window can now match or exceed performance of double-pane windows (FIG. 8 a). Because the single-pane windows still constitute about 40% of all windows, which may be because multi-pane IGUs are often structurally or architecturally incompatible with designs of old, historic buildings, these retrofit products may play an important role in capturing window-related energy losses of pre-existing buildings (FIG. 12).

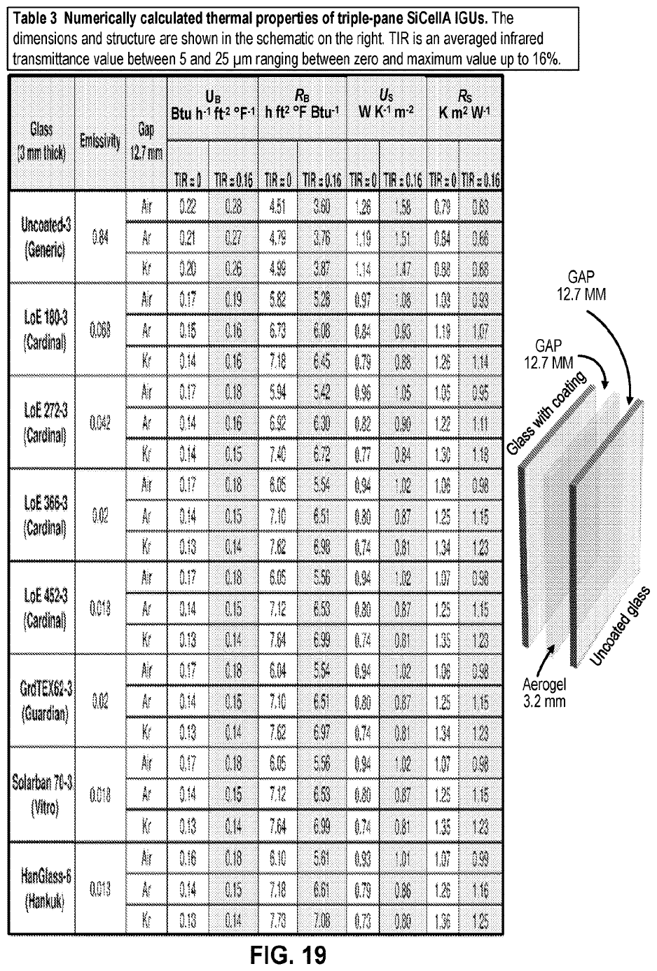

Intended for new construction, new breeds of IGUs containing SiCellA can take many different embodiments, where glass panes with or without different low-emissivity coatings can be used and the thickness of the aerogel filler relative to the overall gap thickness can be varied, along with the thickness of air or other filler gasses. The results of numerical modeling for such SiCellA-IGUs (FIG. 8 b, c) are consistent with experimental measurements performed for a set of prototypes that were manufactured (FIG. 8 d-h), revealing that the general principles commonly applied to designing glass-based multi-pane IGUs can be adequately adapted to using SiCellA panes and fillers. By using inert gases, such as krypton and/or argon to fill parts of the gap of SiCellA-containing IGUs, when the aerogel fills only part of the gap, the R-values can be boosted further (FIG. 8 f, Table 3 in FIG. 19). Adding SiCellA to windows products does not degrade optical properties of the overall IGUs (FIGS. 8 g, h, 9, and 10) because the transmission of SiCellA is very high, so that the transmission light losses mainly come from glass and different coatings on it. In terms of this, SiCellAs are great candidates for the mid panes of IGUs because they allow for higher-than-glass transmission, so that IGUs with large numbers of mid panes can be developed while retaining high overall transmission (FIGS. 8 g, h, 9, and 10).

Modestly transparent cellulose, silica, organic-inorganic hybrid and other aerogels have been demonstrated over the past decades, attracting the initial interest of window manufacturers, but many remaining challenges associated with stringent requirements of glazing products hindered their mainstream applications in windows, skylights and other parts of building envelopes. The present glazing materials and assemblies overcome these major challenges as follows:
1) Mechanically robust SiCellA demonstrated at window-relevant square-meter scales
2) Low haze and high transparency meet the requirement of applications in windows
3) Silanization enables super-hydrophobicity of SiCellA, making them durable
4) Adhesion of SiCellA to plastic films enables their utility in many glazing products
5) Simple fabrication steps and low-cost source materials will help with the deployment

A fundamental difference of SiCellA as compared to conventional aerogels is that the size of e.g., <100 nm pores and e.g., <10 nm diameters of nanofiber forming the network (FIG. 3) is controlled to be much smaller than the visible light wavelengths on window-relevant (square meter) scales, assuring high visible-range light transmission 97-99% (much better than ~92% transmission of generic clear glass) and haze of about 1%. These lightweight materials with mass density of about 1% of glasses density are mechanically robust to take forms of free-standing films that exhibit thermal conductivity of only about 14 mW/(K·m), lower than that of still air. Exemplary SiCellA described herein can be manufactured at low cost and in a highly scalable way, promising to enable entirely new breeds of IGUs, skylights, daylighting, and even SiCellA-containing window frame designs. The abundant source material, which is the never dried wood pulp in the present study, can be also derived from waste of food and beer production industries with the help of bacteria and/or other materials noted herein, with the cost of the end SiCellA film on the order of a dollar per square foot in both cases.

Additionally, the solar gain control can be potentially done with reflective cholesteric filters based on nanocellulose. Accordingly, in some cases, an assembly includes a cholesteric nanocellulose filter.

Deployment of SiCellA could increase the use of glazing in building envelopes because the aerogel-enhanced windows can exceed current and near-future targets for R-values of glazing.

SiCellA's combination of very high transparency and low thermal conductivity at the scale of building materials is a breakthrough, which opens unique opportunities in harnessing and controlling solar energy delivered to buildings, depending on climate- and season-related needs. The low mass density (~1% or less of that of glass) is desired for structural compatibility and retrofitting old windows, as well as key new multi-pane IGU designs. The boosted performance of SiCellA-based IGUs is directly linked to low thermal conductivity and high visible transmission of these materials when used as the middle panes of IGUs. The reflection coefficient at the air-SiCellA interface is ~10 times lower than at the glass-air interface, so that multi-pane assemblies with SiCellA-based middle panes exhibit lower light loss due to reflections as compared to their standard counterparts. For a quadruple-pane IGU assembly, for example, the light loss can be reduced by ~16% upon replacing two middle glass panes with SiCellA counterparts (FIG. 8). Each new SiCellA pane reduces light transmission by less than 1%, so that, hypothetically, even 10-pane IGUs can be possible (not possible for glass mid panes as a glass-based 10-pane IGU blocks nearly all light from passing due to reflections at 20 interfaces). Thus, exemplary assemblies in accordance with the disclosure can include 2, 3, 4, 5, 6, 7, 8, 9, 10, or more e.g., freestanding transparent glazing material sheets or layers. In SiCellA-based IGUs, panes can be separated by gaps of thickness varying within about 6-16 mm, which can be optimized depending on the gas filler (FIG. 8 b-f, FIG. 19). For example, with ~3 mm outer glass and mid-layer SiCellA panes, a triple-pane IGU can be made to have ~21 mm overall thickness of a standard double-pane IGU to replace one while providing better insulation at comparable optical transmission. Designs of IGUs can mix free-standing SiCellA mid-layers and ones adhered to glass panes on their inner surfaces. With thermal conductivity lower than ~26 mW/(K·m) of still air and no convective transfer, the SiCellA-based IGUs can allow for a better insulation per inch than a regular double-pane window with an airgap (FIGS. 8, 9, and 10). Low-emissivity coatings can be applied to glass surfaces, like the inner surface of the exterior glass pane (FIG. 8), though the low-E coating does not provide a significant additional boost of insulation for SiCellA-based IGU assemblies with intrinsic R>9.

Although the initial deployment of SiCellA-based glazing products will likely focus on conventional windows, SiCellA can also be designed to be translucent and backscattering for other glazing uses, like skylight and privacy windows, in which case SiCellA can be deliberately made hazier. High-R values will be attractive for integration of SiCellA-based IGUs with electrochromic and other technologies for privacy and solar gain control, especially in the new breeds of multi-pane IGU designs (FIG. 8), so that all-in-one solutions for high energy efficiency can be realized. The SiCellA-enabled glazing may allow for the building envelopes to better take advantage of external conditions while providing natural occupant comfort and potentially even harnessing energy from the environment.

### PARTICULAR EXAMPLES

Source materials and oxidation of cellulose. Never dried hard wood cellulose pulp was obtained from Nine Dragons Paper (Rumford Division, USA). This hardwood kraft pulp with a water content of 92% had been kept in a wet stage after the bleaching treatment. The pulp was demineralized by stirring it in a HCl (0.1 M) solution for 1 h. after which it was washed with deionized (DI) water by filtration, and then stored at 4° C. without drying. The TEMPO oxidation of the cellulose pulp was started in a basic medium with a pH of 10 (FIG. 11 e). TEMPO (28.92 mg, 0.094 mmol) and NaBr (317.64 mg) were added to the suspension, followed by addition of 1 M NaOCl solution (10 ml). When the pH drop was less than 0.01 per minute, the solution was transferred to a blender and blended for several minutes at 1500 rpm (FIG. 11 f). This breaks down the cellulose fiber agglomerates and allows deeper penetration of the oxidation agent. After a total blending time of about 15 minutes, the solution was placed back on the stirring plate and the pH was again adjusted to 10. This process was repeated until the pH of the solution dropped less than 0.5 after blending. When the pH of the solution on the stirring plate dropped less than 0.03 in one hour, the reaction was considered finished. The solution was then placed in a centrifuge at 9000 rpm for 20 minutes to filter the excess chemicals out of the cellulose solution. This process was repeated several times, each time replacing the waste liquid with DI water to remove remaining chemicals out of the solution until only pure, oxidized cellulose fibers remained. The oxidized nanocellulose was then recovered by centrifugation and washed thoroughly with water, which was then mechanically grinded with a 1500 W grinder (FIG. 11 g), followed by sonication with Branson Sonifier for 15 min at 30% amplitude. Oxidation of the unreacted C6 hydroxyl groups of cellulose into C6 carboxylate groups was further performed using NaClO₂ as the primary oxidant, with catalytic amounts of TEMPO and NaClO in water at a pH of 4.8-6.8. TEMPO again allowed for the selective and efficient conversion of the C6 hydroxyl groups. 1 M dibasic sodium phosphate (2.35 ml) and 1 M monobasic sodium phosphate (2.65 ml) solutions were added to 1 g TEMPO oxidized cellulose nanofiber solution (FIG. 11 h) to act as a buffer during the reaction. This was stirred at 500 rpm for approximately 5 minutes and then 20 mL was removed and set aside to dilute the sodium hypochlorite later before adding it to the reaction vessel. TEMPO (25 mg) and sodium chlorite (1.13 g) were then added to the oxidized cellulose nanofiber dispersions and were stirred at 500 rpm for approximately 20 minutes until these additives were fully dissolved. Sodium hypochlorite (0.455 mL) was then added to the 20 mL separate solution. The diluted sodium hypochlorite was then added to the nanocellulose dispersion, and the reaction vessel was immediately sealed with a tight screw lid. The solution was placed in a water bath at room temperature and was stirred at 500 rpm for approximately 30 minutes. The water bath was then heated to about 60° C. and the reaction was allowed to run continuously for 72 hours. The solution was then placed in a centrifuge at 9000 rpm for 20 minutes to filter the excess chemicals out of the cellulose solution. This process was repeated several times, each time replacing the waste liquid with DI water to wash out remaining chemicals until only pure, oxidized cellulose fibers remained. Next, the dispersion was sonicated with a Branson Sonifier for 30 minutes and filtered with Whatman filter paper 2 to get the final oxidized cellulose nanofiber dispersion in water.

### Preparation of Aerogels

Aqueous TEMPO-oxidized cellulose nanofiber dispersions with concentrations ranging from 0.5% to 2% were poured into plastic molds of desired thickness ranging from 1.5 mm to 25 mm (FIG. 12 a, b). To initiate gelation, 0.5 M HCl was sprayed into the dispersion for few seconds with a fine spray. Keeping the sprayed HCl spread over the dispersion, it was allowed to stand for 30 minutes without any disturbance. The resulting hydrogel was then moved to a 0.1M HCl solvent bath for 24 hours to make sure that the gelation was complete. The ensuing rigid hydrogel was taken from the mold and the acid was then washed out by DI water and then moved to a water-ethanol mixture (50 vol. % each) followed by the solvent exchange to ethanol (FIG. 12 b-d). Since the ethanol makes azeotrope with water, we used an elevated temperature (60° C.) during the water to ethanol exchange (FIG. 12 4 c, d). The ensuing alcogel is then rolled and moved to a critical point dryer (CPD) chamber to dry (FIG. 12 g and FIG. 13 a-c), with the initial chamber temperature set at 5° C. and pressure set at 800 psi. The next step involved purging ethanol from the chamber and replacing it with liquid CO₂. Then, the temperature was raised to 40° C. and the pressure was set at 1500 psi and then ethanol leftover was purged while within supercritical phase for 30 minutes. The final step of the process, bleeding of supercritical CO₂, was then started slowly, at 25 psi/min, and the chamber was gradually depressurized within about 1 hour. The resulting aerogels were kept at 60° C. for 1 day before characterization and functionalization (FIG. 12 i, h). CPD chambers with cylinder-shaped inner volume of two different dimensions were used (diameter×height sizes of 16.5 cm×2.5 cm and 16.5 cm×104 cm), depending on the size of SiCellA being dried (FIGS. 12 g-k and 13 c-f).

### Silanization of Cellulose Gels

Most commonly (and for all SiCellA samples characterized in FIGS. 1-8), silanization of cellulose molecules was done after fabricating aerogels, as depicted in FIG. 2 f and FIG. 12 g-k, though modification at the hydrogel stage can be also done (FIG. 4 e, f, h). The aerogel-stage silanization was done using 1H,1H,2H,2H-perfluorooctyltriethoxysilane as the coupling agent (FIG. 2 f), where the aerogels were functionalized in a closed container with 1H,1H,2H,2H-perfluorooctyltriethoxysilane at 100° C. for 2 hours (FIG. 2f). The aerogel sample and silane were placed for heating in a vacuum oven to complete the reaction (FIG. 12) at optimized reaction time, silane amount and temperature (FIG. 2 f). The obtained superhydrophobic aerogels (FIG. 2 h) retained the desired optical and thermal properties. Alternatively, yielding similar results, silanization of cellulose molecules of the fabricated hydrogel was done using vinyltrimethoxysilane as the coupling agent (FIG. 12 d-f). The fabricated hydrogels were dipped in a circulating bath of ethanol/water mixture at the 60:40 ratio with the optimized concentration (5%) of the coupling agent for 4 hours. In order to ensure efficient coating of vinyltrimethoxysilane coupling agent on the individual exposed cellulose fibers, the pH of the solution was maintained between 3.5 and 4 by using the METREPAK Phydrion buffers. Afterwards, the ethanol-water mixture was drained out and replaced with pure ethanol by repeated washing. The ensuing alcogels of salinized nanocellulose were dried in a CPD chamber (FIG. 12 f-h).

### Thermal Characterization

Thermal conductivity k of aerogels was characterized by two methods: using a commercial heat flow meter Netzsch HFM 446 or by measuring the heat flux through the sample using a sensor (FluxTeq), depending on dimensions of the samples. In the former case, the aerogels were prepared with dimensions specified in the instrument's guidelines, with lateral size ranging from 10 cm×10 cm to 20 cm×20 cm, whereas the latter method was used for samples of sizes from square inch to square meter.

Thermal conductivity of large-area aerogel films and the U-values of SiCellA aerogel prototypes were determined by measuring the heat flux through the samples. To study the heat exchange between the interior and exterior environments separated by a window retrofitted with a SiCellA film and to measure its U value, an environmental hot/cold box system (FIG. 14) was constructed. The overall dimensions of the box were 1.3 m×1.3 m×0.5 m, with its insulating double walls built using a commercial polystyrene foam of 38 mm wall thickness and R=10 (FOAMULAR NGX). The hot/cold box could fit samples of different aspect ratios and areas up to 1 m². To mimic the heat exchange between the building's interior and the outdoor environment under different conditions, the inside of the box was heated with an electronically controlled heating band or cooled with the supply of dry ice. Thus, the internal temperature of the box, which corresponds to the outdoor ambient temperature, could be changed within a wide range of ~−70° C.-+100° C. The air temperatures inside Te and outside Ti the box and temperatures of the window surfaces were continuously monitored with thermocouples. The heat flux sensor (FluxTeq) was used to measure the heat flux flow q through the measured assembly or IGU. Data from the heat flux sensors and thermocouples was collected by a computer using an automatic data acquisition software (FIG. 14). The heat flow through the characterized SiCellA material, assembly or IGU could be monitored over hours or days, if necessary. This system was used to measure thermal conductivity, thermal conductance, U and R-values. For example, the U value of a window retrofitted with an aerogel film or IGU was calculated as U=q/(Ti—Te) using the measured values of q, Ti and Te.

### Optical Characterization

The ultraviolet through visible and near infrared spectra were measured by a Cary 500 scan spectrophotometer in transmission mode. The total and diffused transmission spectra in the visible region (400-800 nm) of aerogel films were recorded with an integrating sphere (Labsphere DRA-CA-5500). The haze coefficient values, quantifying the amounts of scattered light, were calculated based on the total and diffused transmission measurements using the integrating sphere following the ASTM D1003 (Standard Test Method for Haze and Luminous Transmittance), commonly used for haze measurements in windows applications. For optical transmittance and haze measurements, the samples were mounted at the entry port of the integrating sphere and calibration was done using diffuse reflectance standards. The samples, with an area of 10 cm×10 cm for free-standing, retrofitted samples and 10 cm×10 cm×3.6 cm for triple pane IGU's were normally inserted in the instrument's standard sample compartment. To enable mounting of these modestly large samples, the standard sample compartment covers were removed and a light-tight customized housing was used.

Fourier-transform infrared (FTIR) spectroscopy experiments were performed in the mid-infrared (2.5-25 μm) region using a Nicolet 6700 FTIR spectrometer with a DTGS detector (4000-400 cm⁻¹) in a transmission mode. A gold-coated 3-integrating sphere (PIKE Technologies, Mid-IR Upward-looking InegratIR) was used in both reflection and transmission modes with a wide-band (4000-500 cm⁻¹) Mercury Cadmium Telluride detector. These measurements allowed for characterizing thermal-infrared-range transmissivity of various unmodified and SiCellA aerogels shown in FIG. 5 d. The weighted transmissive emittance (W/m²·μm), i.e., the ratio of the thermal transmittance from aerogels to the radiation from an ideal black body at the same temperature, were calculated by multiplying black-body emittance at 300 K by the averaged transmittance of aerogels at each wavelength (FIG. 5 e). Those data were used as an input for modeling of thermal performance of glazing products.

Optical microscopy observations of hydrogel, alcogel and aerogel samples were performed using an upright Olympus microscope BX-51. A digital camera Nikon D50 mounted on the microscope and small-magnification (2× or 4×) Olympus objectives were used to take photographs of water droplets on the surface of SiCellA films, which allowed for measuring the contact angle and determining surface wettability using ImageJ software (freeware. National Institutes of Health). Refractive index values of SiCellA aerogels were obtained by measuring a minimum deviation angle by a prism made of this material, where the laser beam from a 632 nm helium-neon laser (Edmund Optics) was deviated by an aerogel prism (FIG. 4 f) placed on a rotating holder (Olympus). By measuring a minimum deviation angle of the beam and the corresponding incidence angle, the refractive index values of transparent aerogels were determined with high accuracy.

Additionally, the spectral dispersion of a refractive index (FIG. 4 d) was obtained from the measured absorption data of aerogel films by using the Kramers-Kronig relation. To measure optical birefringence in 12 mm-thick aerogel samples with porosity 99.1%, a Berek compensator U-CTB (Olympus) mounted on the microscope in an optical path immediately after the SiCellA sample was used. The color appearance of objects seen through materials and IGUs may be an important property, which can be quantitatively described by a color rendering index (CRI). The CRI of SiCellA films and SiCellA-IGUs was determined based on light transmission measured by a Cary 500 scan spectrophotometer while following ASTM standards and was found to be >99%, meeting requirements for IGUs.

### Mechanical Characterization

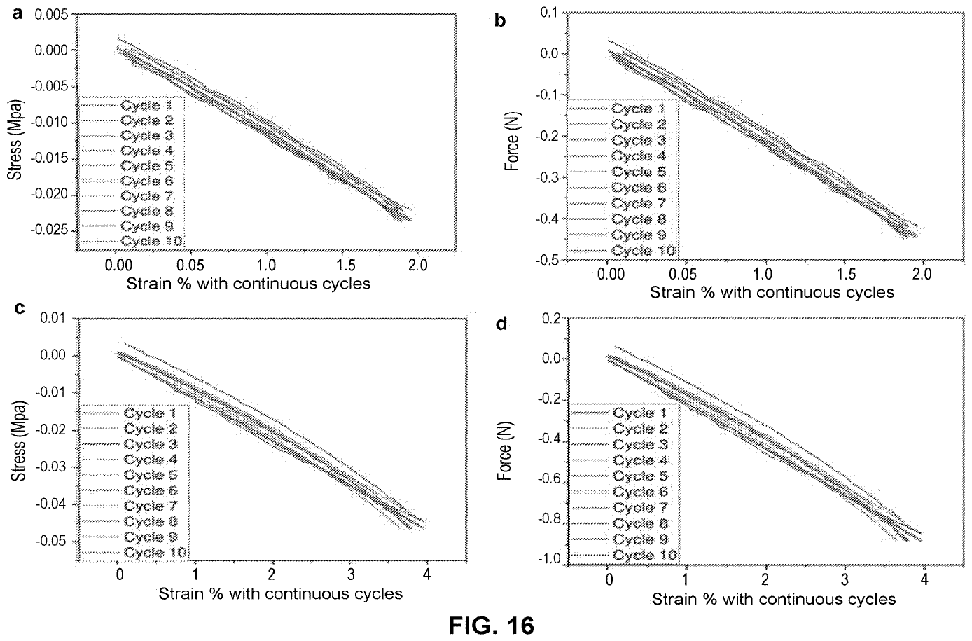

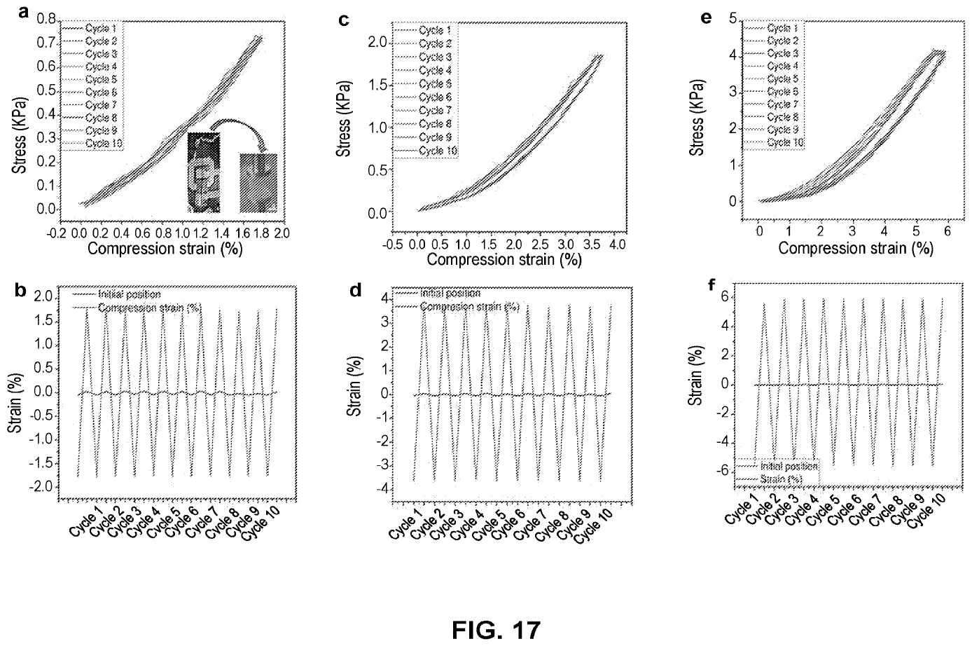

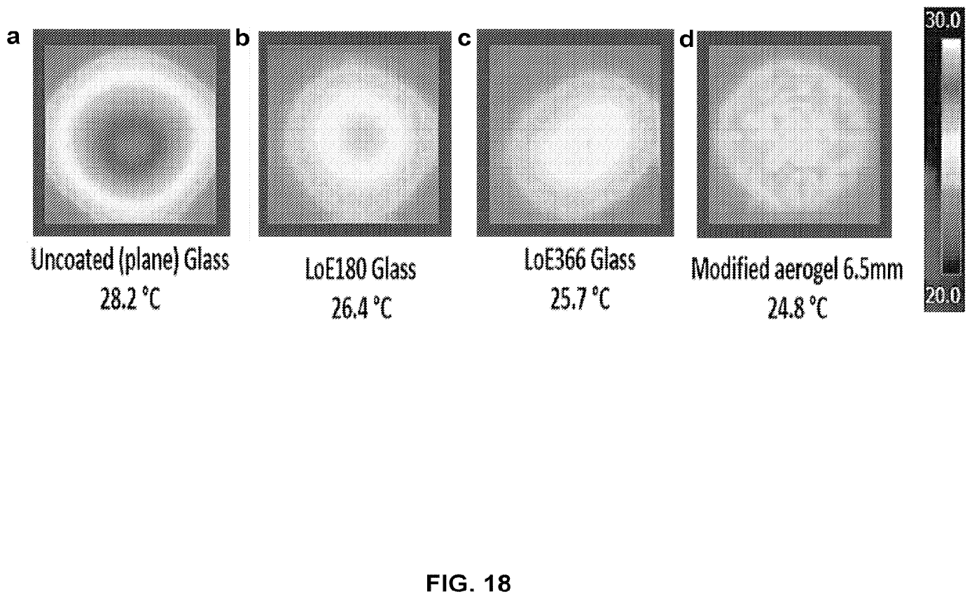

Tensile mechanical measurements were done using a DMA 850 apparatus (TA Instruments) with a standard tension clamp attachment. The compression, three-point bending, and cycles of compression and elongation were recorded using the RSA-G2 Solids Analyzer. The applied force and displacement of the clamp were recorded during these measurements. Initial dimensions of samples were used to convert these measurements to stress and strain with TRIOS software (TA Instruments). Mechanical properties were also probed under cyclic tension/compression up to a maximum strain of 6% for silanized aerogels (FIS. 6c and 17). In each cycle, the stress rose linearly with increasing strain to a maximum value, at which the load was removed and the stress typically came back to the original value (FIGS. 16 and 17), indicating no hysteresis behavior at up to 6% strain on compression and elongation. Below 6% strain, the maximum value of stress remained constant with increasing the cycle number, confirming the overall robust mechanical performance of SiCellA materials (FIGS. 6, 10, and 11).

### Material Stability and Window Product Durability

Thermogravimetric analysis (TGA) was performed for both unmodified and silanized aerogels in the N2 atmosphere at 25-500° C. TGA runs were performed with a Netsch STA 449 F1 Jupiter thermogravimeter with an alumina crucible at a heating rate of 10° C./min in argon atmosphere. The thermal stability was characterized using a basic mass loss rate, dm/dt, normalized by the total mass lost. The differential scanning calorimetry (DSC) was performed using the Q1000 instrument (TA Instruments) with an aluminum hermetic crucible. All tests were performed in the N2 environment, with the heating and cooling rates set to 10° C. min⁻¹ and with temperature ramping between 30° C. and 250° C. for one cycle total.

High relative humidity (RH) environments are common for IGUs, especially when installed in tropical or sub-tropical climate regions. The excessive moisture and oxygen in the air can react, for example, with the secondary silicone sealant, accelerating its aging process and degrading the IGU's performance. A high RH environmental test chamber was used to generate a temperature regime of 80° F. (27° C.) at a high RH of 80%. SiCellA-containing IGUs were placed in the chamber for 14 days. The properties of the IGUs before and after the test were then measured, revealing robust performance (FIG. 7 e). Another common test, the fogging test (also known as a “chemical outgassing test”) is intended to determine the resistance of preassembled, sealed IGUs to fogging, which could occur due to chemical outgassing of materials and assembly components within the IGU. The test is conducted during 14 days in a special box equipped with an ultraviolet light source, an air circulating fan, and a cooling plate according to the standard ASTM E2189, with the outcomes revealing no degradation of physical properties (FIG. 7 d). For the ultraviolet exposure test, the IGUs were placed into the ultraviolet illumination chamber and exposed to a 500 W MLU ultraviolet radiator with the output power of 40 W/m² or higher, where the ultraviolet exposure photons have energies comparable to the dissociation energies of polymer bonds (300-1000 kJ/mole). SiCellA-containing IGUs were kept in the chamber at 50±3° C. for 30 days of exposure and then characterized, revealing no substantial property degradation (FIG. 7f).

### Condensation Resistance

Cold temperatures of a window's inner surface can cause moisture from the interior of a room to condense on it as droplets of water when these temperatures are below the dew point. Being highly likely at high indoor RH, the condensation impacts transparency of windows and the indoor humidity, which may degrade the indoor air quality. To compare condensation resistance of SiCellA-based window products and their counterparts, we measured their condensation resistance factor (CRF), which quantifies how well a window resists condensation on the interior-facing surface. Typical CRF values are 5-15 for single-pane, 35-50 for double-pane and 60-80 for triple-pane IGUs. To measure CRF, we used a homebuilt cold box chamber (FIG. 14 a). The temperature inside the chamber, which represents the outside ambient environment and exterior temperature, was lowered using dry ice and the temperature of all IGUs surfaces was continuously monitored by thermocouples (FluxTeq). FIG. 7 c shows dependencies of the temperature of the interior pane surface on the exterior temperature for different characterized fenestrations. The condensation resistance factor was calculated as CRF=100 (Tc−Te)/(Ti−Te), where Tc, Ti and Te are, respectively, temperature of the IGU's inner surface facing the room, internal, room temperature and external temperature experimentally measured when water condenses on the IGU. Condensation was detected visually and also via measuring the drop of intensity of a 632 nm laser beam (Edmund Optics) passing through the center of IGU.

### Nanoscale Characterization

Transmission electron microscopy (TEM) characterization was done by recording tilt series on a Titan Krios G3i at 300 kV under low dose conditions. SerialEM was used to record the tilt series and reconstruction of the tomographic data was done using IMOD. The individual cellulose nanofibers within aqueous dispersions were negatively stained with 1% phosphotungstic acid before the TEM imaging on a Tecnai ST20 200 kV TEM (FIG. 3 a-d). Thin aerogels were fabricated and dried on 300 mesh Au carbon film TEM grids for imaging to avoid possible changes of the internal structure during transfers and processing. Characterization of nanoscale porosity of aerogels was also carried out with Nitrogen absorption-desorption measurements, which were performed on a Quantachrome NOVA touch pore analyzer at 77 K. Before these measurements, the aerogel samples (about 50 mg each) were kept at 60° C. for 48 hours, outgassed under vacuum at 50° C. for at least 24 hours and then squeezed into tube-shaped sample holders. By using ASiQwin software, the specific surface area was calculated based on the Brunauer-Emmett-Teller (BET) multi-point method, and then pore size distribution was evaluated according to the density functional theory models implemented within the instrument's software. The specific surface area was determined by the BET methods from the linear region of the isotherms in the relative pressure (P/P₀) range of 0.03-0.3. The total pore volumes were estimated from the amount of N₂ adsorbed at P/P₀=0.99 for porosities of the studied aerogels ranging within 99.3-97.5%. Adsorption isotherms, total surface area, individual and cumulative pore surface area of the unmodified and silanized aerogel were characterized (FIGS. 3 f, g and FIG. 15).

### Modeling and Characterization of SiCellA-Based Window Products

Numerical simulations of SiCellA-insulated glazing units (FIG. 19) were performed using the Berkeley Lab WINDOW 7.7 software while assuming 1000 mm by 1000 mm lateral dimensions and SiCellA's thermal conductivity of ~0.014 W/(m·K) (FIG. 5 a, b). All spectral characteristics were experimentally obtained using spectrometers, as described above, and then loaded into the user-defined input of International Glazing Database (IGDB) while using Berkeley Lab Optics 6 for defining optical layers and calculating spectral data. The glass panes were assumed to be made of a generic clear glass (3-mm thick), unless noted differently. For retrofits, either a generic thin glass (0.5-mm thick) or a polyethylene terephthalate (PET) film of 0.2-mm thickness were used as back-supporting protective layers of the SiCellA-based retrofit prototypes. The SiCellA were fabricated and adhered to plastic substrates used as a mold during fabrication and as a protective layer in the retrofit product. Alternatively, free-standing films of SiCellA could be easily electrostatically adhered to glass substrates and plastic support layers during retrofit installation, so that only edges of the retrofitted windows needed sealing. For low emissivity coated glass panes, we used 3-mm thick LoĒ-180, 272, and 366 window products of Cardinal Glass Industries, with the physical characteristics available in the IGDB. IGUs with different lateral dimensions, ranging from 10 cm×10 cm to 100 cm×100 cm, and the number of glass or SiCellA panes were fabricated and experimentally characterized. The 3 mm thick free-standing SiCellA aerogels were used as the middle panes of SiCellA based triple-pane IGUs. The gap thickness between glass and SiCellA panes was defined by spacers from Super Spacer SS1466 Gray Edgetech with 6.3 mm and 12.7 mm width. The boundaries of the IGU's were sealed airtight with Silicone Foam and Metal Spacer I. G. Sealant (C.R. Laurence Co., Inc).

### Techno-Economic Analysis

The technoeconomic analysis was performed to study the fully loaded production cost of commercial mass production of the SiCellA for a monolithic layer as a window-insulation product. The production cost analysis estimates a preliminary upper limit for the fully loaded production cost with bulk material freight-on-board costs and factory operating and capital expenditures which include direct and indirect labor, labor burden, production and ancillary energy, waste management, building lease, production equipment, equipment maintenance, plant design and installation, and building build-out costs. Quantitative assumptions used in the model include the baseline production volume of 1 million square feet per year of a SiCellA that is 3.2 mm thick with a density of 150 μg/ml. Both the wood-pulp-derived and by bacteria-synthesized cellulose sources are used in the production cost analysis. Although results presented in this work correspond to wood-derived cellulose source, the bacteria-synthesized cellulose is a promising approach to obtain cellulose nanofibers, so that the initial source of bacterial pellicles obtained with Acetobacter hansenii were also used in the analysis. For the model, production equipment capacity was scaled to meet the aforementioned production volume and to manufacture an aerogel product in ~1 m×2 m sheets. Extensive use of chemicals and solvent recycling is implemented in the model. With 5-year straight-line depreciation/amortization of capital expenditures assumed, the estimated fully loaded production cost of the SiCellA is $17.20/m² when using the wet wood pulp source and $17.31/m² when using the bacteria-synthesized cellulose source, with a maximum possible calculated costs of ~$53.76/m² and minimum possible costs ~$10.75/m². This estimated cost range takes into account variations in direct labor costs, material freight-on-board costs, aerogel-cellulose densities and cellulose production efficiency.

1. A transparent glazing material comprising:
an aerogel comprising a network of cellulose nanofibers; and
silicon functional groups bonded to surfaces of the cellulose nanofibers,
wherein a thermal conductivity of the transparent glazing material is less than 26 mW/(K·m) or less than 20 mW/(K·m) or less than 15 mW/(K·m).

2-3. (canceled)

4. The transparent glazing material of claim 1, wherein the transparent glazing material exhibits superhydrophobicity.

5. The transparent glazing material of claim 1, wherein an average width of the cellulose nanofibers is less than 10 nm or between about 4 nm and about 6 nm.

6. The transparent glazing material of claim 1, wherein an average length of the cellulose nanofibers is greater than 100 nm or greater than 1000 nm or between about 200 nm and about 2000 nm.

7. The transparent glazing material of claim 16, wherein the aerogel is optically anisotropic.

8. The transparent glazing material of claim 1, wherein an average pore size of the aerogel is less than 100 nm or between about 2 nm and about 50 nm.

9. An assembly comprising:
the transparent glazing material of claim 1; and
a first glass pane.

10. The assembly of claim 9, further comprising a substrate attached to the transparent glazing material.

11. The assembly of claim 10, wherein the substrate comprises one or more of plastic or glass.

12. The assembly of claim 10, wherein the transparent glazing material is attached to the substrate via electrostatic charge.

13. The assembly of claim 10, further comprising a low-emissivity coating between the substrate and the transparent glazing material.

14. The assembly of claim 9, further comprising a second glass pane, wherein the transparent glazing material is interposed between the first and second glass panes.

15. The assembly of claim 9, further comprising an inert gas.

16. The assembly of claim 9, comprising three or more panes of glass.

17. The assembly of claim 9, wherein the transparent glazing material is a free-standing transparent glazing material.

18. A method of forming a transparent aerogel, the method comprising the steps of:
forming cellulose nanofibers having an average diameter of less than 10 nm and an average length greater than 100 nm;
functionalizing the cellulose nanofibers with carboxylate anions to form functionalized cellulose nanofibers;
forming a hydrogel from a network of the functionalized cellulose nanofibers;
forming an aerogel from the hydrogel; and
silanizing a surface of the functionalized cellulose nanofibers.

19. The method of claim 18, wherein the step of silanizing the surface comprises vapor-phase silanization of the aerogel.

20. The method of claim 18, wherein the step of silanizing the surface comprises silanization of the functionalized cellulose nanofibers of the hydrogel.

21. The method of claim 18, wherein the step of silanizing the surface comprises exposing the surface to a chlorine-free silanizing agent.

22. The method of claim 18, wherein the transparent aerogel is formed on a surface of a rollable substrate, and wherein a combination of the substrate and the transparent aerogel are rollable in a roll having a diameter of less than about 1 centimeter.

23-24. (canceled)
